(19) United States
(12) Patent Application Publication
(10) Pub. No.: US 2026/0186252 A1
(43) Pub. Date: Jul. 2, 2026

(54) IMAGING OPTICAL LENS

(71) Applicant: Changzhou AAC Raytech Optronics Co., Ltd., Changzhou City (CN)

(72) Inventor: Tao Zhang, Changzhou (CN)

(21) Appl. No.: 19/292,973

(22) Filed: Aug. 7, 2025

Related U.S. Application Data
(63) Continuation of application No. PCT/CN2024/144649, filed on Dec. 31, 2024.

(51) Int. Cl. G02B 13/00; G02B 9/62

(52) U.S. Cl. CPC G02B 13/0045; G02B 9/62

(57) ABSTRACT

Embodiments of the present disclosure disclose an imaging optical lens, the imaging optical lens includes six lenses that are sequentially arranged from an object-side to an image-side as follows: a first lens with negative refractive power, a second lens with positive refractive power, a third lens with positive refractive power, a fourth lens with negative refractive power, a fifth lens with positive refractive power, and a sixth lens with negative refractive power. Through the configuration of these lenses, the imaging optical lens has a large aperture, a wide angle, ultra-thinness, and excellent optical performance. It is beneficial to control the total optical length (TOL) of the imaging optical lens, rationally allocate the focal lengths of the lens, reduce the degree of light deflection when passing through the lenses, effectively correct astigmatism and distortion, eliminate chromatic aberration, reduce aberrations, and thereby enhancing imaging quality.

### TECHNICAL FIELD

Embodiments of the present disclosure relate to the technical field of optics, and in particular to an imaging optical lens.

### BACKGROUND

Imaging optical lenses are widely used in mobile devices, vehicle-mounted cameras, monitoring equipment, and the like, especially in smart mobile devices. As users' demands for the shooting performance of smart mobile devices increase, existing imaging optical lenses are increasingly unable to meet market needs.

In existing imaging optical lenses, the number or size of lenses is often increased to improve imaging quality. This results in a longer total optical length of the entire lens and hinders the implementation of miniaturized designs. Additionally, due to design limitations, existing imaging optical lenses suffer from significant chromatic aberration, which is detrimental to high-quality imaging and fails to meet the design requirements of large apertures, wide angles, and ultra-thinness.

### SUMMARY

The embodiments of the present disclosure are intended to provide an imaging optical lens with a large aperture, a wide angle, ultra-thinness, and excellent optical performance. The lens is capable of controlling the total optical length of the imaging optical lens, rationally allocating the focal lengths of the lenses, mitigating the deflection extent of light when passing through the lenses, effectively correcting astigmatism and distortion, eliminating chromatic aberration, reducing aberrations, and thereby enhancing imaging quality.

In order to solve the above technical problems, the embodiments of the present disclosure provide an imaging optical lens. The imaging optical lens includes six lenses that are sequentially arranged from the object-side to the image-side as follows:
a first lens with negative refractive power;
a second lens with positive refractive power;
a third lens with positive refractive power;
a fourth lens with negative refractive power;
a fifth lens with positive refractive power; and
a sixth lens with negative refractive power,
an object-side surface of the first lens is concave in a paraxial region, and an image-side surface of the first lens is concave in a paraxial region;
an object-side surface of the second lens is convex in a paraxial region, and an image-side surface of the second lens is concave in a paraxial region;
an object-side surface of the third lens is convex in a paraxial region, and an image-side surface of the third lens is convex in a paraxial region;
an object-side surface of the fourth lens is concave in a paraxial region, and an image-side surface of the fourth lens is concave in a paraxial region;
an object-side surface of the fifth lens is concave in a paraxial region, and an image-side surface of the fifth lens is convex in a paraxial region;
an object-side surface of the sixth lens is convex in a paraxial region, and an image-side surface of the sixth lens is concave in a paraxial region; and
R1 represents a central curvature radius of the object-side surface of the first lens;
R2 represents a central curvature radius of the image-side surface of the first lens;
f1 represents a focal length of the first lens;
d1 represents an on-axis thickness of the first lens;
d2 represents an on-axis distance between the image-side surface of the first lens and the object-side surface of the second lens;
d3 represents an on-axis thickness of the second lens;
R9 represents a central curvature radius of the object-side surface of the fifth lens;
R10 represents a central curvature radius of the image-side surface of the fifth lens;
f5 represents a focal length of the fifth lens;
f6 represents a focal length of the sixth lens;
TTL represents a total optical length from the object surface to the image surface of the imaging optical lens;
and the imaging optical lens satisfies the following relationships:

$$- 0.40 \leq ( R 1 + R 2 ) / ( R 1 - R 2 ) \leq 0. ;$$

$$0.2 \leq ( d 1 + d 2 + d 3 ) / TTL \leq 0 \text{.30} ;$$

$$- 1.8 \; 0 \leq ( f 5 - f 6 ) / f 1 \leq - 1 \text{.20} ;$$

$$1. \leq ( R 9 + R 10 ) / ( R 9 - R 10 ) \leq 1.20 .$$

In some embodiments, f2 represents a focal length of the second lens, f3 represents a focal length of the third lens, and the imaging optical lens satisfies a following relationship: 1.20≤f2/f3≤3.00.

In some embodiments, IH represents a full field-of-view (1.0H) image-height of the imaging optical lens, f represents a focal length of the imaging optical lens, and the imaging optical lens satisfies a following relationship: 0.80≤IH*f/TTL≤1.50.

In some embodiments, f represents a focal length of the imaging optical lens, and the imaging optical lens further satisfies a following relationship: −1.67≤f1/f≤−1.43; 0.05≤d1/TTL≤0.09.

In some embodiments, f represents a focal length of the imaging optical lens, f2 represents a focal length of the second lens, and the imaging optical lens satisfies the following relationships: −4.02≤(R3+R4)/(R3−R4)≤−2.03; 2.20≤f2/f≤4.28; 0.10≤d3/TTL≤0.14.

In some embodiments, f represents a focal length of the imaging optical lens, R5 represents a central curvature radius of an object-side surface of the third lens, R6 represents a central curvature radius of an image-side surface of the third lens, f3 represents a focal length of the third lens, d5 represents an on-axis thickness of the third lens, and the imaging optical lens satisfies the following relationships: 0.07≤(R5+R6)/(R5−R6)≤0.30; 1.20≤f3/f≤1.83; 0.08≤d5/TTL≤0.11.

In some embodiments, f represents a focal length of the imaging optical lens, R7 represents a central curvature radius of an object-side surface of the fourth lens, R8 represents a central curvature radius of an image-side surface of the fourth lens, f4 represents a focal length of the fourth lens, d7 represents an on-axis thickness of the fourth lens, and the imaging optical lens satisfies the following relationships: 0.74≤(R7+R8)/(R7−R8)≤0.98; −3.56≤f4/f≤−2.31; 0.04≤d7/TTL≤0.06.

In some embodiments, f represents a focal length of the imaging optical lens, d9 represents an on-axis thickness of the fifth lens, and the imaging optical lens satisfies the following relationships: 0.70≤f5/f≤0.97; 0.19≤d9/TTL≤0.23.

In some embodiments, f represents a focal length of the imaging optical lens, R11 represents a central curvature radius of an object-side surface of the sixth lens, R12 represents a central curvature radius of an image-side surface of the sixth lens, d11 represents an on-axis thickness of the sixth lens, and the imaging optical lens satisfies the following relationships: 2.76≤(R11+R12)/(R11−R12)≤3.12; −1.86≤f6/f≤−1.09; 0.07≤d11/TTL≤0.09.

In some embodiments, IH represents a full field-of-view (1.0H) image-height of the imaging optical lens, and the imaging optical lens satisfies the following relationship: 1.60≤TTL/IH≤1.94.

The beneficial effects of the embodiments of the present disclosure are as follows. Through the arrangement of the lenses, an imaging optical lens has a large aperture, a wide angle, ultra-thinness, and excellent optical performance. It is beneficial to control the total optical length of the imaging optical lens, rationally allocate the focal lengths of the lenses, reduce the degree of light deflection when passing through the lenses, effectively correct astigmatism and distortion, eliminate chromatic aberration, reduce aberrations, and thereby enhancing imaging quality.

### BRIEF DESCRIPTION OF THE DRAWINGS

One or more embodiments are illustrated by the figures in the corresponding drawings, and these exemplified descriptions do not constitute limitations on the embodiments. Elements with the same reference numerals in the drawings represent similar elements, and the diagrams in the drawings do not constitute proportional limitations unless otherwise stated.

FIG. 1 is a schematic structural diagram of an imaging optical lens in a first embodiment of the present disclosure.

FIG. 2 is a schematic diagram of the field curvature and distortion of the imaging optical lens shown in FIG. 1.

FIG. 3 is a schematic diagram of the lateral color of the imaging optical lens shown in FIG. 1.

FIG. 4 is a schematic diagram of the longitudinal aberration of the imaging optical lens shown in FIG. 1.

FIG. 5 is a schematic structural diagram of an imaging optical lens in a second embodiment of the present disclosure.

FIG. 6 is a schematic diagram of the field curvature and distortion of the imaging optical lens shown in FIG. 5.

FIG. 7 is a schematic diagram of the lateral color of the imaging optical lens shown in FIG. 5.

FIG. 8 is a schematic diagram of the longitudinal aberration of the imaging optical lens shown in FIG. 5.

FIG. 9 is a schematic structural diagram of an imaging optical lens in a third embodiment of the present disclosure.

FIG. 10 is a schematic diagram of the field curvature and distortion of the imaging optical lens shown in FIG. 9.

FIG. 11 is a schematic diagram of the lateral color of the imaging optical lens shown in FIG. 9.

FIG. 12 is a schematic diagram of the longitudinal aberration of the imaging optical lens shown in FIG. 9.

FIG. 13 is a schematic structural diagram of an imaging optical lens in a fourth embodiment of the present disclosure.

FIG. 14 is a schematic diagram of the field curvature and distortion of the imaging optical lens shown in FIG. 13.

FIG. 15 is a schematic diagram of the lateral color of the imaging optical lens shown in FIG. 13.

FIG. 16 is a schematic diagram of the longitudinal aberration of the imaging optical lens shown in FIG. 13.

FIG. 17 is a schematic structural diagram of an imaging optical lens in a fifth embodiment of the present disclosure.

FIG. 18 is a schematic diagram of field curvature and distortion of the imaging optical lens shown in FIG. 17.

FIG. 19 is a schematic diagram of the lateral color of the imaging optical lens shown in FIG. 17.

FIG. 20 is a schematic diagram of the longitudinal aberration of the imaging optical lens shown in FIG. 17.

FIG. 21 is a schematic structural diagram of an imaging optical lens in a sixth embodiment of the present disclosure.

FIG. 22 is a schematic diagram of field curvature and distortion of the imaging optical lens shown in FIG. 21.

FIG. 23 is a schematic diagram of the lateral color of the imaging optical lens shown in FIG. 21.

FIG. 24 is a schematic diagram of the longitudinal aberration of the imaging optical lens shown in FIG. 21.

FIG. 25 is a schematic structural diagram of an imaging optical lens according to a comparative embodiment.

FIG. 26 is a schematic diagram of field curvature and distortion of the imaging optical lens shown in FIG. 25.

FIG. 27 is a schematic diagram of the lateral color of the imaging optical lens shown in FIG. 25.

FIG. 28 is a schematic diagram of the longitudinal aberration of the imaging optical lens shown in FIG. 25.

### DETAILED DESCRIPTION OF THE EMBODIMENTS

The following will be described in detail with reference to the accompanying drawings to illustrate the purpose, technical solutions and advantages of the embodiments of the present disclosure. However, those skilled in the art should appreciate that many technical details are proposed in the various embodiments of the present disclosure in order to enable the reader to better understand the present disclosure. However, the technical solutions claimed in the present disclosure can be implemented even without these technical details and various changes and modifications based on the following embodiments.

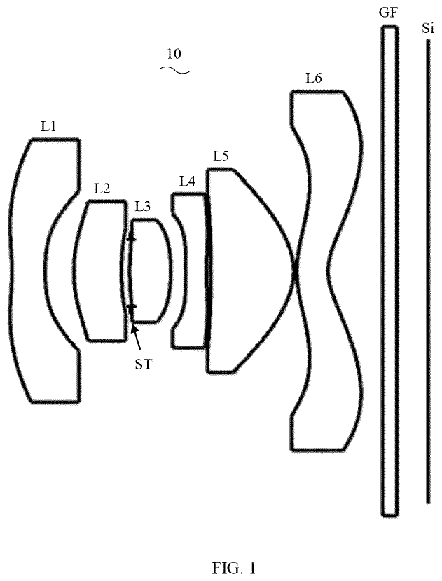

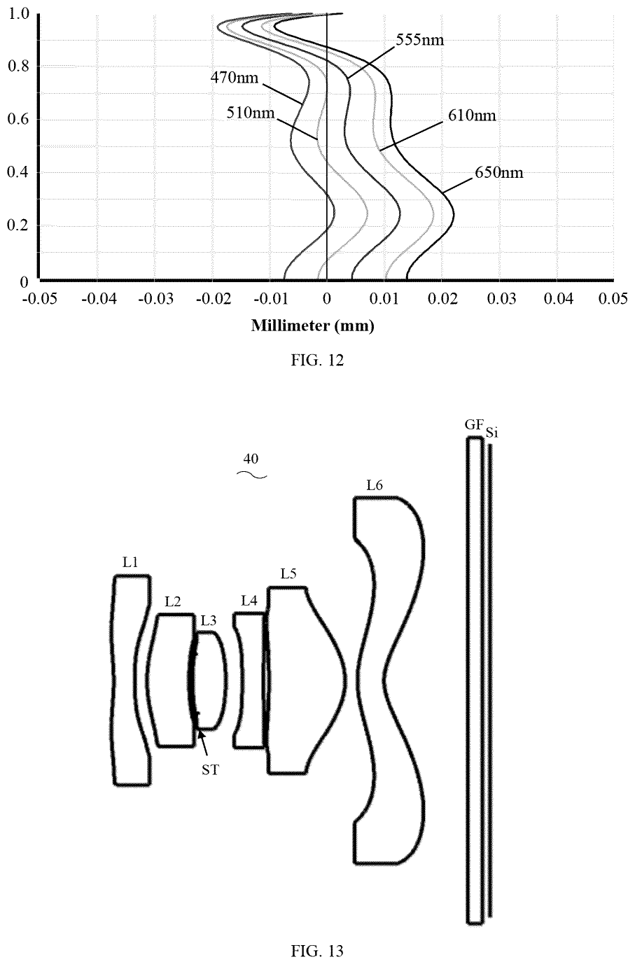

Referring to FIG. 1, FIG. 5, FIG. 9, FIG. 13, FIG. 17, and FIG. 21, the technical solution of the present disclosure provides imaging optical lenses 10, 20, 30, 40, 50, and 60. The imaging optical lenses 10, 20, 30, 40, 50, and 60 each include six lenses. For example, a first lens L1 having negative refractive power, a second lens L2 having positive refractive power, a third lens L3 having positive refractive power, a fourth lens L4 having negative refractive power, a fifth lens L5 having positive refractive power, a sixth lens L6 having negative refractive power, which are sequentially arranged from an object-side to an image-side. An object-side surface of the first lens L1 is concave in a paraxial region, and an image-side surface of the first lens L1 is concave in a paraxial region. An object-side surface of the second lens L2 is convex in a paraxial region, and an image-side surface of the second lens L2 is concave in a paraxial region. An object-side surface of the third lens L3 is convex in a paraxial region, and an image-side surface of the third lens L3 is convex in a paraxial region. An object-side surface of the fourth lens L4 is concave in a paraxial region, and the image-side surface of the fourth lens L4 is concave in a paraxial region; an object-side surface of the fifth lens L5 is concave in a paraxial region, and an image-side surface of the fifth lens L5 is convex in a paraxial region. An object-side surface of the sixth lens L6 is convex in a paraxial region, and an image-side surface of the sixth lens L6 is concave in a paraxial region.

A central curvature radius of the object-side surface of the first lens L1 is defined as R1, a central curvature radius of the image-side surface of the first lens L1 is defined as R2, a focal length of the first lens L1 is defined as f1, an on-axis thickness of the first lens L1 is defined as d1, an on-axis distance between the image-side surface of the first lens L1 and the object-side surface of the second lens L2 is defined as d2, an on-axis thickness of the second lens L2 is defined as d3, a central curvature radius of the object-side surface of the fifth lens L5 is defined as R9, a central curvature radius of the image-side surface of the fifth lens L5 is defined as R10, a focal length of the fifth lens L5 is defined as f5, a focal length of the sixth lens L6 is defined as f6, and a total optical length of the imaging optical lenses 10, 20, 30, 40, 50, and 60 is defined as TTL, and the following relationship formulas should be satisfied:

$$- 0.4 \; 0 \leq ( R 1 + R 2 ) / ( R 1 - R 2 ) \leq 0. \qquad ( 1 )$$

$$0.2 \leq ( d 1 + d 2 + d 3 ) / TTL \leq 0.3 \qquad ( 2 )$$

$$- 1.8 \leq ( f 5 - f 6 ) / f 1 \leq - 1.2 \qquad ( 3 )$$

$$1. \leq ( R 9 + R 10 ) / ( R 9 - R 10 ) \leq 1 \text{.20} \qquad ( 4 )$$

The relationship formula (1) specifies the shape of the first lens L1. Within the range defined by relationship (1), it is beneficial to correct astigmatism and distortion of the imaging optical lenses 10, 20, 30, 40, 50, and 60, so that the distortion value satisfies |distortion|≤8.5% and the possibility of vignetting can be reduced.

The relationship formula (2) specifies the ratio of the distance from an object-side surface of the first lens L1 to an image-side surface of the second lens L2 to the total optical length TTL of the imaging optical lens. Within this range, it helps to reduce the total optical length TTL of the imaging optical lenses 10, 20, 30, 40, 50, and 60, realizing an ultra-thin design.

The relationship formula (3) defines the relationship among the focal length f1 of the first lens L1, the focal length f5 of the fifth lens L5, and the focal length f6 of the sixth lens L6. Within the range defined by the relationship formula (3), by reasonably distributing the focal lengths of the imaging optical lenses 10, 20, 30, 40, 50, and 60, the imaging optical lenses can have better imaging quality and lower sensitivity.

The relationship formula (4) specifies the shape of the fifth lens L5. Within this range, it is beneficial to reduce the degree of light deflection when passing through the fifth lens L5, which can well reduce aberrations.

A focal length of the second lens is defined as f2, and a focal length of the third lens is defined as f3. The following relationship formula should be satisfied:

$$1.2 \leq f 2 / f 3 \leq 3.00 \qquad ( 5 )$$

The relationship formula (5) specifies the ratio range between the focal length f2 of the second lens L2 and the focal length f3 of the third lens L3. Within this range, by reasonably distributing the focal lengths of the imaging optical lenses 10, 20, 30, 40, 50, and 60, the imaging optical lenses can have better imaging quality and lower sensitivity. The full field-of-view (1.0H) image-height of the imaging optical lens is defined as IH, and the focal length of the imaging optical lens is defined as f, and the following relationship formula should be satisfied:

$$0.8 \leq IH * f / TTL \leq 1.50 \qquad ( 6 )$$

Within the range defined by the relationship formula (6), the total optical length of the imaging optical lenses 10, 20, 30, 40, 50, and 60 can be effectively reduced, which is beneficial to the miniaturization of the imaging optical lenses 10, 20, 30, 40, 50, and 60. At the same time, it is easy to correct distortion, axial chromatic aberration, and other aberrations, maintaining good optical performance of the imaging optical lenses 10, 20, 30, 40, 50, and 60.

Under the condition of satisfying the above relationships, the imaging optical lenses 10, 20, 30, 40, 50, and 60 have good optical performance and can meet the design requirements of a large aperture, a wide angle, and an ultra-thinness. According to the characteristics of the imaging optical lenses 10, 20, 30, 40, 50, and 60, they are particularly suitable for mobile phone camera lens modules and WEB camera lenses equipped with high-pixel CCD, CMOS, and other imaging elements.

Based on the above relationships and achievable functions, the characteristics of each lens are further detailed as follows.

It should be noted that the units of the above central curvature radius, focal length, on-axis distance, and total optical length are all millimeters (mm).

A focal length of the imaging optical lens is defined as f, and the following relationship formulas should be satisfied:

$$- 1.67 \leq f 1 / f \leq - 1 \text{.43} \qquad ( 7 )$$

$$0.05 \leq d 1 / TTL \leq 0. 09 \qquad ( 8 )$$

The relationship formula (7) defines the ratio range between the focal length f1 of the first lens L1 and the focal length f of the imaging optical lenses 10, 20, 30, 40, 50, and 60. Within this range, it helps to improve the optical performance of the imaging optical lenses 10, 20, 30, 40, 50, and 60.

The relationship formula (8) defines the ratio range between the on-axis thickness d1 of the first lens L1 and the total optical length TTL of the imaging optical lenses 10, 20, 30, 40, 50, and 60. Within this range, it is beneficial to control the total optical length TTL of the imaging optical lenses 10, 20, 30, 40, 50, and 60.

The focal length of the imaging optical lens is defined as f, the focal length of the second lens L2 is f2, and the on-axis thickness of the second lens L2 is d3, and the following relationship formulas should be satisfied:

$$- 4.02 \leq ( R 3 + R 4 ) / ( R 3 - R 4 ) \leq - 2 \text{.03} \qquad ( 9 )$$

$$2.2 \leq f 2 / f \leq 4.28 \qquad ( 10 )$$

$$0.1 \leq d 3 / TTL \leq 0. 14 \qquad ( 11 )$$

The relationship formula (9) specifies the shape of the second lens L2. Within this range, the degree of light deflection when passing through the second lens L2 can be reduced, effectively reducing aberrations. The relationship formula (10) defines the ratio between the focal length f2 of the second lens L2 and the focal length f of the imaging optical lenses 10, 20, 30, 40, 50, and 60. Within this range, it helps to reduce aberrations and improve imaging quality. The relationship formula (11) defines the on-axis thickness d3 of the second lens L2. Within this range, the total optical length TTL of the imaging optical lenses 10, 20, 30, 40, 50, and 60 can be effectively reduced, which is beneficial to miniaturization.

A focal length of the imaging optical lens is defined as f, a central curvature radius of the object-side surface of the third lens L3 is defined as R5, a central curvature radius of the image-side surface of the third lens L3 is defined as R6, a focal length of the third lens L3 is defined as f3, and an on-axis thickness of the third lens L3 is defined as d5, and the following relationship formulas should be satisfied:

$$0.07 \leq ( R 5 + R 6 ) / ( R 5 - R 6 ) \leq 0 \text{.30} \qquad ( 12 )$$

$$1.2 \leq f 3 / f \leq 1.83 \qquad ( 13 )$$

$$0.08 \leq d 5 / TTL \leq 0.11 \qquad ( 14 )$$

The relationship formula (12) specifies the shape of the third lens L3. Within this range, it helps to improve imaging quality. The relationship formula (13) defines the focal length f3 of the third lens L3. Within this range, the optical performance of imaging optical lenses 10, 20, 30, 40, 50, and 60 can be improved, thereby reducing aberrations. The relationship formula (14) defines the on-axis thickness d5 of the third lens L3. Within this range, it is beneficial to control the total optical length TTL of the imaging optical lenses 10, 20, 30, 40, 50, and 60.

A focal length of the imaging optical lens is defined as f, a central curvature radius of the object-side surface of the fourth lens L4 is defined as R7, a central curvature radius of the image-side surface of the fourth lens L4 is defined as R8, a focal length of the fourth lens L4 is defined as f4, and an on-axis thickness of the fourth lens L4 is defined as d7, and the following relationship formulas should be satisfied:

$$0.74 \leq ( R 7 + R 8 ) / ( R 7 - R 8 ) \leq 0 \text{.98} \qquad ( 15 )$$

$$- 3.5 \; 6 \leq f 4 / f \leq - 2.31 \qquad ( 16 )$$

$$0.04 \leq d 7 / TTL \leq 0. 06 \qquad ( 17 )$$

The relationship formula (15) specifies the shape of the fourth lens L4. Within this range, the spherical aberration of the imaging optical lenses 10, 20, 30, 40, 50, and 60 can be effectively corrected, improving imaging quality. The relationship formula (16) defines the focal length f4 of the fourth lens L4. Within this range, it is beneficial to improve the optical performance of the imaging optical lenses 10, 20, 30, 40, 50, and 60. The relationship formula (17) defines the on-axis thickness d7 of the fourth lens L4. Within this range, the total optical length TTL of the imaging optical lenses 10, 20, 30, 40, 50, and 60 can be controlled, which is beneficial to miniaturization.

A focal length of the imaging optical lens is defined as f, and an on-axis thickness of the fifth lens is defined as d9. The following relationship formulas should be satisfied:

$$0.7 \leq f 5 / f \leq 0 \text{.97} \qquad ( 18 )$$

$$0.19 \leq d 9 / TTL \leq 0.23 \qquad ( 19 )$$

The relationship formula (18) defines the focal length f5 of the fifth lens L5. Within this range, it is beneficial to reduce aberrations and improve imaging quality. The relationship (19) defines the on-axis thickness d9 of the fifth lens L5. Within this range, it is beneficial to reduce the total optical length TTL of the imaging optical lenses 10, 20, 30, 40, 50, and 60.

A focal length of the imaging optical lens is defined as f, a central curvature radius of the object-side surface of the sixth lens L6 is R11, a central curvature radius of the image-side surface of the sixth lens L6 is R12, and an on-axis thickness of the sixth lens L6 is d11, The following relationship formulas should be satisfied:

$$2.76 \leq ( R 11 + R 12 ) / ( R 11 - R 12 ) \leq 3 \text{.12} \qquad ( 20 )$$

$$- 1.8 \; 6 \leq f 6 / f \leq - 1.09 \qquad ( 21 )$$

$$0.07 \leq d 11 / TTL \leq 0. 09 \qquad ( 22 )$$

The relationship formula (20) defines the shape of the sixth lens L6. Within this range, the degree of light deflection when passing through the sixth lens L6 can be reduced, effectively reducing aberrations. The relationship formula (21) defines the focal length f6 of the sixth lens L6. Within this range, the sixth lens L6 has appropriate negative refractive power, which is beneficial to reduce aberrations. The relationship formula (22) defines the on-axis thickness d11 of the sixth lens L6. Within this range, it is beneficial to reduce the total optical length TTL of the imaging optical lenses 10, 20, 30, 40, 50, and 60, realizing an ultra-thin design.

In this solution, the full field-of-view (1.0H) image-height of the imaging optical lenses 10, 20, 30, 40, 50, and 60 is IH, and the following relationship formula should be satisfied:

$$1.6 \leq TTL / IH \leq 1.94 \qquad ( 23 )$$

Within this range, the ultra-thin design of the imaging optical lenses 10, 20, 30, 40, 50, and 60 can be realized.

In this solution, the f-number of the imaging optical lenses 10, 20, 30, 40, 50, and 60 is FNO, and the following relationship formula should be satisfied:

$$2. \leq FNO \leq 2.3 \qquad ( 24 )$$

The relationship formula (24) specifies the f-number of the imaging optical lenses 10, 20, 30, 40, 50, and 60. Under this limitation, the imaging optical lenses 10, 20, 30, 40, 50, and 60 can have a large aperture.

In this solution, the first lens L1, the second lens L2, the third lens L3, the fourth lens L4, the fifth lens L5, and the sixth lens L6 are all made of plastic. Each lens can also be made of other materials.

In this solution, the aperture ST of the imaging optical lenses 10, 20, 30, 40, 50, and 60 is arranged between the second lens L2 and the third lens L3. However, the aperture ST is not limited to being between the second lens L2 and the third lens L3, and can also be arranged at other positions. In addition, the imaging optical lenses 10, 20, 30, 40, 50, and 60 may also be provided with one or more optical elements such as an optical filter GF, where the optical filter GF may be a glass cover plate or an optical filter (filter). For example, an optical filter may be arranged on the image-side of the sixth lens L6.

The present disclosure provides imaging optical lenses 10, 20, 30, 40, 50, and 60 with a large aperture, a wide angle, ultra-thinness, and excellent optical performance through the above lens configuration. It is beneficial to control the total optical length TTL of the imaging optical lenses 10, 20, 30, 40, 50, and 60, reasonably distribute the focal lengths of the lenses, reduce the degree of light deflection when passing through the lenses, effectively correct astigmatism and distortion, eliminate chromatic aberration, reduce aberrations, and improve imaging quality.

The imaging optical lenses 10, 20, 30, 40, 50, and 60 of the present disclosure will be described below with examples. The symbols recorded in each example are as shown in Table 1, and the units of focal length, on-axis distance, central curvature radius, on-axis thickness, inflection point position, and stagnation point position are all millimeters (mm).

TTL: total optical length (the on-axis distance from the object-side surface of the first lens L1 to the imaging surface), in millimeters.

F-number (FNO): the ratio of the effective focal length of the imaging optical lens to the entrance pupil diameter.

Image height (IH) of 1.0 field of view: the field height corresponding to the effective pixel of the sensor (i.e., half of the diagonal length of the effective pixel area of the sensor).

Field of view (FOV) of 1.0 field of view: the field angle corresponding to the effective pixel of the sensor.

Preferably, the object-side surface and/or image-side surface of the lens can also be provided with inflection points and/or stagnation points to meet high-quality imaging requirements.

Next, the technical solution of the present disclosure will be specifically described with six embodiments, and a comparative embodiment will be provided as a reference to illustrate that the technical effects of the present disclosure cannot be achieved when exceeding the range of the above relationships.

### First Embodiment

FIG. 1 is a schematic structural diagram of the imaging optical lens 10 in the first embodiment. The following shows the design data of the imaging optical lens 10 in the first embodiment of the present disclosure.

Table 1 lists the central curvature radius R of the object-side surface and image-side surface, the on-axis thickness of the lens, the on-axis distance d between lenses, the refractive index nd, and the Abbe number vd of the first lens L1 to the sixth lens L6 constituting the imaging optical lens 10 in the first embodiment of the present disclosure. It should be noted that in this embodiment, the units of distance, radius, and thickness are all millimeters (mm).

TABLE 1

| | R | D | | nd | | vd | |
|---|---|---|---|---|---|---|---|
| R1 | −3.288 | d1= | 0.487 | nd1 | 1.5444 | νd1 | 55.82 |
| R2 | 3.396 | d2= | 0.418 | | | | |
| R3 | 2.014 | d3= | 0.698 | nd2 | 1.6153 | νd2 | 25.94 |
| R4 | 3.836 | d4= | 0.119 | | | | |
| ST | ∞ | / | / | / | / | / | / |
| R5 | 4.170 | d5= | 0.600 | nd3 | 1.5444 | νd3 | 55.82 |
| R6 | −2.474 | d6= | 0.217 | | | | |
| R7 | −323.023 | d7= | 0.302 | nd4 | 1.6700 | νd4 | 19.39 |
| R8 | 4.013 | d8= | 0.063 | | | | |
| R9 | −33.847 | d9= | 1.220 | nd5 | 1.5444 | νd5 | 55.82 |
| R10 | −0.878 | d10= | 0.044 | | | | |
| R11 | 1.567 | d11= | 0.456 | nd6 | 1.6400 | νd6 | 23.54 |
| R12 | 0.735 | d12= | 0.800 | | | | |
| R13 | ∞ | d13= | 0.210 | ndg1 | 1.5168 | vg1 | 64.17 |
| R14 | ∞ | d14= | 0.453 | | | | |

The meanings of the symbols in the above table are as follows:
R: the curvature radius of the optical surface, or the central curvature radius for lenses;
ST: aperture;
R1: the central curvature radius of the object-side surface of the first lens L1;
R2: the central curvature radius of the image-side surface of the first lens L1;
R3: the central curvature radius of the object-side surface of the second lens L2;
R4: the central curvature radius of the image-side surface of the second lens L2;
R5: the central curvature radius of the object-side surface of the third lens L3;
R6: the central curvature radius of the image-side surface of the third lens L3;
R7: the central curvature radius of the object-side surface of the fourth lens L4;
R8: the central curvature radius of the image-side surface of the fourth lens L4;
R9: the central curvature radius of the object-side surface of the fifth lens L5;
R10: the central curvature radius of the image-side surface of the fifth lens L5;
R11: the central curvature radius of the object-side surface of the sixth lens L6;
R12: the central curvature radius of the image-side surface of the sixth lens L6;
R13: the curvature radius of the object-side surface of the optical filter GF;
R14: the curvature radius of the image-side surface of the optical filter GF;
d: the on-axis thickness of the lens; on-axis distance between lenses;
d1: the on-axis thickness of the first lens L1;
d2: the on-axis distance from the image-side surface of the first lens L1 to the object-side surface of the second lens L2;
d3: the on-axis thickness of the second lens L2;
d4: on-axis distance from the image-side surface of the second lens L2 to the object-side surface of the third lens L3;
d5: the on-axis thickness of the third lens L3;
d6: the on-axis distance from the image-side surface of the third lens L3 to the object-side surface of the fourth lens LA;
d7: the on-axis thickness of the fourth lens L4;
d8: the on-axis distance from the image-side surface of the fourth lens L4 to the object-side surface of the fifth lens L5;
d9: the on-axis thickness of the fifth lens L5;
d10: the on-axis distance from the image-side surface of the fifth lens L5 to the object-side surface of the sixth lens L6;
d11: the on-axis thickness of the sixth lens L6;
d12: the on-axis distance from the image-side surface of the sixth lens L6 to the object-side surface of the optical filter GF;
d13: the on-axis thickness of the optical filter GF;
d14: the on-axis distance from the image-side surface of the optical filter GF to the image surface Si;
nd: the refractive index of the d-line (the d-line refers to green light with a wavelength of 555 nm);
nd1: the refractive index of the d-line of the first lens L1;
nd2: the refractive index of the d-line of the second lens L2;
nd3: the refractive index of the d-line of the third lens L3;
nd4: the refractive index of the d-line of the fourth lens L4;
nd5: the refractive index of the d-line of the fifth lens L5;
nd6: the refractive index of the d-line of the sixth lens L6;
ndg: the refractive index of the d-line of the optical filter GF;
vd: the Abbe number;
vd1: the Abbe number of the first lens L1;
vd2: the Abbe number of the second lens L2;
vd3: the Abbe number of the third lens L3;
vd4: the Abbe number of the fourth lens L4;
vd5: the Abbe number of the fifth lens L5;
vd6: the Abbe number of the sixth lens L6;
vg: the Abbe number of the optical filter GF.

TABLE 2

| | Conic | | | | | |
|---|---|---|---|---|---|---|
| | coefficient | Aspheric coefficient | | | | |
| | K | A4 | A6 | A8 | A10 | A12 |
| R1 | −4.6459E+01 | 1.8618E−01 | −1.8929E−01 | 1.5956E−01 | −1.0110E−01 | 4.5290E−02 |
| R2 | −1.0986E+01 | 5.0324E−01 | −6.3936E−01 | 7.9553E−01 | −4.4944E−01 | −8.0365E−01 |
| R3 | −3.6104E+00 | 7.9314E−02 | −2.7033E−01 | 8.5880E−01 | −3.0596E+00 | 7.2054E+00 |
| R4 | 2.8841E+01 | 2.4555E−02 | −1.1125E+00 | 1.6170E+01 | −2.0937E+02 | 2.7520E+03 |
| R5 | 1.7706E+01 | −2.4126E−02 | 5.3331E−01 | −2.4073E+01 | 7.0553E+02 | −1.4655E+04 |
| R6 | 5.3466E−02 | −1.2773E−01 | −4.6262E+00 | 1.0464E+02 | −1.5162E+03 | 1.5050E+04 |
| R7 | 9.9000E+01 | −5.0853E−01 | 2.8671E+00 | −5.1150E+01 | 5.9697E+02 | −4.6018E+03 |
| R8 | 1.4682E+00 | −4.5508E−01 | 3.6726E+00 | −3.5049E+01 | 2.1061E+02 | −8.4289E+02 |
| R9 | −2.6302E+01 | −1.6325E−01 | 3.1172E+00 | −2.9384E+01 | 1.5959E+02 | −5.7783E+02 |
| R10 | −1.0046E+00 | 2.9064E−01 | −2.2079E−01 | −1.0976E+00 | 5.5009E+00 | −1.3707E+01 |
| R11 | −4.1945E+00 | −1.3278E−01 | 1.5120E−01 | −5.1593E−01 | 1.2260E+00 | −1.7533E+00 |
| R12 | −4.1152E+00 | −3.1068E−02 | −1.3110E−01 | 2.6824E−01 | −2.7926E−01 | 1.8487E−01 |
| | Conic | | | | | |
| | coefficient | Aspheric coefficient | | | | |
| | K | A14 | A16 | A18 | A20 | A22 |
| R1 | −4.6459E+01 | −1.3699E−02 | 2.6454E−03 | −2.9353E−04 | 1.4194E−05 | 0.0000E+00 |
| R2 | −1.0986E+01 | 1.9349E+00 | −1.7581E+00 | 7.7792E−01 | −1.3849E−01 | 0.0000E+00 |
| R3 | −3.6104E+00 | −1.0456E+01 | 9.1117E+00 | −4.3509E+00 | 8.7038E−01 | 0.0000E+00 |
| R4 | 2.8841E+01 | −3.3259E+04 | 3.0897E+05 | −2.0330E+06 | 9.2621E+06 | −2.8875E+07 |
| R5 | 1.7706E+01 | 2.1550E+05 | −2.2557E+06 | 1.6848E+07 | −8.9564E+07 | 3.3519E+08 |
| R6 | 5.3466E−02 | −1.0597E+05 | 5.3874E+05 | −1.9937E+06 | 5.3658E+06 | −1.0380E+07 |
| R7 | 9.9000E+01 | 2.4608E+04 | −9.4179E+04 | 2.6187E+05 | −5.3022E+05 | 7.7372E+05 |
| R8 | 1.4682E+00 | 2.3701E+03 | −4.8087E+03 | 7.1170E+03 | −7.6818E+03 | 5.9762E+03 |
| R9 | −2.6302E+01 | 1.4853E+03 | −2.7788E+03 | 3.8134E+03 | −3.8287E+03 | 2.7758E+03 |
| R10 | −1.0046E+00 | 2.3331E+01 | −2.9420E+01 | 2.7994E+01 | −1.9897E+01 | 1.0310E+01 |
| R11 | −4.1945E+00 | 1.6322E+00 | −1.0442E+00 | 4.7279E−01 | −1.5323E−01 | 3.5389E−02 |
| R12 | −4.1152E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −4.6459E+01 | 0.0000E+00 | 0.0000E+00 | 0.0000E+00 | 0.0000E+00 | / |
| R2 | −1.0986E+01 | 0.0000E+00 | 0.0000E+00 | 0.0000E+00 | 0.0000E+00 | / |
| R3 | −3.6104E+00 | 0.0000E+00 | 0.0000E+00 | 0.0000E+00 | 0.0000E+00 | / |
| R4 | 2.8841E+01 | 6.0261E+07 | −8.0255E+07 | 6.1460E+07 | −2.0512E+07 | / |
| R5 | 1.7706E+01 | −8.6111E+08 | 1.4434E+09 | −1.4204E+09 | 6.2191E+08 | / |
| R6 | 5.3466E−02 | 1.4050E+07 | −1.2621E+07 | 6.7561E+06 | −1.6303E+06 | / |
| R7 | 9.9000E+01 | −7.9249E+05 | 5.4055E+05 | −2.2046E+05 | 4.0665E+04 | / |
| R8 | 1.4682E+00 | −3.2613E+03 | 1.1840E+03 | −2.5673E+02 | 2.5147E+01 | / |
| R9 | −2.6302E+01 | −1.4132E+03 | 4.7905E+02 | −9.7051E+01 | 8.8883E+00 | / |
| R10 | −1.0046E+00 | −3.7552E+00 | 9.0680E−01 | −1.3002E−01 | 8.3680E−03 | / |
| R11 | −4.1945E+00 | −5.6918E−03 | 6.0616E−04 | −3.8425E−05 | 1.0975E−06 | / |
| R12 | −4.1152E+00 | 1.1258E−05 | −6.6808E−07 | 2.4495E−08 | −4.2365E−10 | / |

It should be noted that the aspheric surfaces of each lens in this embodiment use the aspheric surface shown in the following relationship formula (25). However, the specific form of the following relationship formula (25) is only an example. In fact, the present disclosure is not limited to the aspheric polynomial form identified in relationship formula (25).

$$z = ( {c}^{2} / r ) / \{ 1 + {[ 1 - ( k + 1 ) ( {c}^{2} / {r}^{2} ) ]}^{1 / 2} \} + A 4 {c}^{4} + A 6 {c}^{6} + A 8 {c}^{8} + A 10 {c}^{10} + A 12 {c}^{12} + A 14 {c}^{14} + A 16 {c}^{16} + A 18 {c}^{18} + A 20 {c}^{20} + A 22 {c}^{22} + A 24 {c}^{24} + A 26 {c}^{26} + A 28 {c}^{28} + A 30 {c}^{30} \qquad ( 25 )$$

Wherein, k is the conic coefficient, A4, A6, A8, A10, A12, A14, A16, A18, A20, A22, A24, A26, A28, A30 are aspheric coefficients, c is the curvature at the center of the optical surface, r is the vertical distance from a point on the aspheric curve to the optical axis, z is the aspheric depth (the vertical distance between a point on the aspheric surface at a distance r from the optical axis and the tangent plane at the vertex of the aspheric surface on the optical axis).

In addition, in the subsequent Table 15, the values corresponding to the various parameters in the first embodiment and the parameters specified in the relationship formulas are also listed.

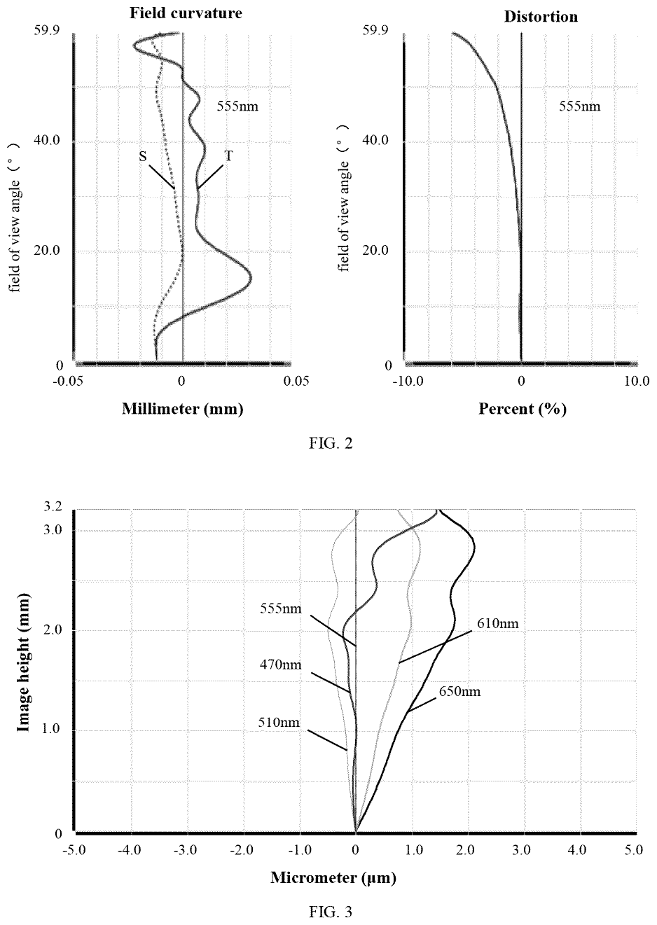

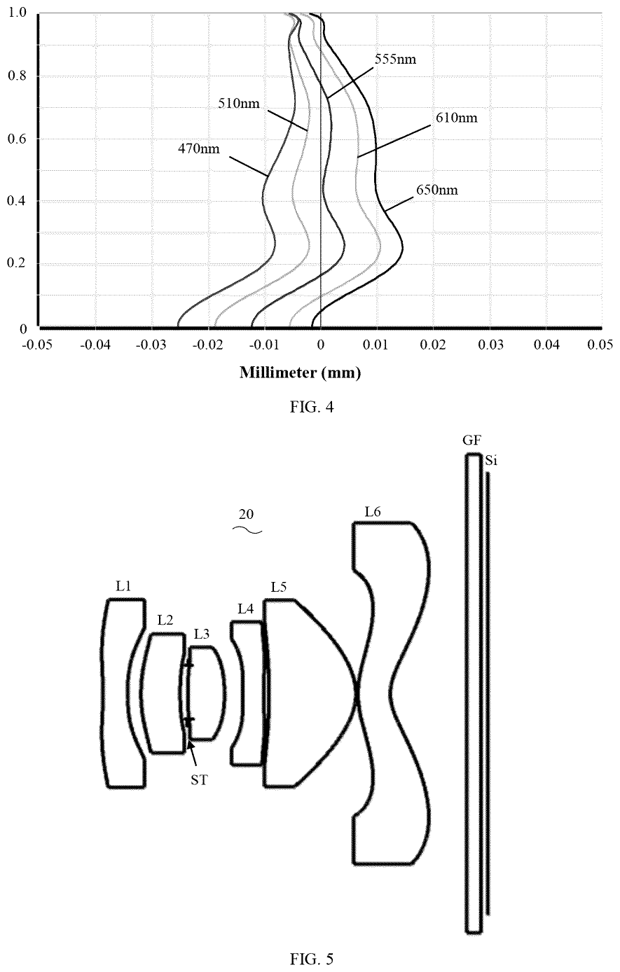

FIG. 2 is a schematic diagram showing the field curvature and distortion of light with a wavelength of 555 nanometers (nm) after passing through the imaging optical lens 10 of the first embodiment. The field curvature S in FIG. 2 is a field curvature in the sagittal direction, and T is a field curvature in the meridian direction. FIG. 3 is a schematic diagram showing the lateral color of light with wavelengths of 470 nm, 510 nm, 555 nm, 610 nm, and 650 nm after passing through the imaging optical lens 10 in the first embodiment. FIG. 4 is a schematic diagram showing the longitudinal aberration of light with wavelengths of 470 nm, 510 nm, 555 nm, 610 nm, and 650 nm after passing through the imaging optical lens 10 of the first embodiment.

As shown in Table 15, the first embodiment satisfies all relationship formulas.

In this embodiment, the pupil entering diameter (ENPD) of the imaging optical lens 10 is 0.873 mm, the full field-of-view (1.0H) image-height IH is 3.201 mm, and the field of view angle of the 1.0 field of view is 119.85°. The imaging optical lens 10 has the characteristics of a large aperture, a wide angle, and an ultra-thinness. Its on-axis and off-axis chromatic aberrations are fully corrected, and it has excellent optical performance.

### Second Embodiment

FIG. 5 is a schematic structural diagram of the imaging optical lens 20 in the second embodiment. The second embodiment is basically the same as the first embodiment, and the meanings of the symbols in the second embodiment is the same as the first embodiment. Only the differences are listed below.

Tables 3 and 4 show the design data of the imaging optical lens 20 in the second embodiment of the present disclosure.

TABLE 3

| | R | D | | nd | | vd | |
|---|---|---|---|---|---|---|---|
| R1 | −3.857 | d1= | 0.356 | nd1 | 1.5444 | νd1 | 55.82 |
| R2 | 3.857 | d2= | 0.193 | | | | |
| R3 | 2.236 | d3= | 0.566 | nd2 | 1.6153 | νd2 | 25.94 |
| R4 | 3.721 | d4= | 0.110 | | | | |
| ST | ∞ | / | / | / | / | // | |
| R5 | 3.874 | d5= | 0.533 | nd3 | 1.5444 | νd3 | 55.82 |
| R6 | −2.176 | d6= | 0.265 | | | | |
| R7 | −27.850 | d7= | 0.298 | nd4 | 1.6700 | νd4 | 19.39 |
| R8 | 4.011 | d8= | 0.079 | | | | |
| R9 | −9.107 | d9= | 1.262 | nd5 | 1.5444 | νd5 | 55.82 |
| R10 | −0.823 | d10= | 0.031 | | | | |
| R11 | 1.377 | d11= | 0.467 | nd6 | 1.6400 | νd6 | 23.54 |
| R12 | 0.656 | d12= | 1.103 | | | | |
| R13 | ∞ | d13= | 0.210 | ndg1 | 1.5168 | vg1 | 64.17 |
| R14 | ∞ | d14= | 0.094 | | | | |

TABLE 4

| | Conic | | | | | |
|---|---|---|---|---|---|---|
| | coefficient | Aspheric coefficient | | | | |
| | K | A4 | A6 | A8 | A10 | A12 |
| R1 | −8.1594E+01 | 1.7842E−01 | −1.9069E−01 | 1.6055E−01 | −1.0163E−01 | 4.5257E−02 |
| R2 | −1.3339E+01 | 4.6505E−01 | −6.9031E−01 | 7.8020E−01 | −4.3373E−01 | −7.9812E−01 |
| R3 | −5.1913E+00 | 7.4278E−02 | −3.0250E−01 | 8.9799E−01 | −3.0447E+00 | 7.1848E+00 |
| R4 | 2.7730E+01 | −1.0006E−02 | −8.0351E−01 | 1.5957E+01 | −2.1100E+02 | 2.7524E+03 |
| R5 | 2.3628E+01 | −4.8751E−02 | 3.3102E−01 | −2.3635E+01 | 7.0656E+02 | −1.4655E+04 |
| R6 | 8.6132E−01 | −1.0375E−01 | −4.7166E+00 | 1.0480E+02 | −1.5161E+03 | 1.5050E+04 |
| R7 | 1.1284E+03 | −5.3629E−01 | 2.8333E+00 | −5.0995E+01 | 5.9726E+02 | −4.6022E+03 |
| R8 | 3.9092E+00 | −4.9873E−01 | 3.6731E+00 | −3.5033E+01 | 2.1061E+02 | −8.4288E+02 |
| R9 | −2.1232E+02 | −1.6876E−01 | 3.1188E+00 | −2.9392E+01 | 1.5960E+02 | −5.7783E+02 |
| R10 | −9.1740E−01 | 2.9910E−01 | −2.1838E−01 | −1.0949E+00 | 5.5026E+00 | −1.3707E+01 |
| R11 | −3.7912E+00 | −1.3334E−01 | 1.5021E−01 | −5.1679E−01 | 1.2261E+00 | −1.7533E+00 |
| R12 | −3.5597E+00 | −3.2939E−02 | −1.3036E−01 | 2.6788E−01 | −2.7919E−01 | 1.8487E−01 |
| | Conic | | | | | |
| | coefficient | Aspheric coefficient | | | | |
| | K | A14 | A16 | A18 | A20 | A22 |
| R1 | −8.1594E+01 | −1.3705E−02 | 2.6929E−03 | −3.0360E−04 | 1.4088E−05 | 0.0000E+00 |
| R2 | −1.3339E+01 | 1.9311E+00 | −1.7487E+00 | 7.6197E−01 | −1.2269E−01 | 0.0000E+00 |
| R3 | −5.1913E+00 | −1.0515E+01 | 9.1875E+00 | −4.3133E+00 | 8.3594E−01 | 0.0000E+00 |
| R4 | 2.7730E+01 | −3.3252E+04 | 3.0901E+05 | −2.0329E+06 | 9.2619E+06 | −2.8876E+07 |
| R5 | 2.3628E+01 | 2.1549E+05 | −2.2557E+06 | 1.6848E+07 | −8.9564E+07 | 3.3519E+08 |
| R6 | 8.6132E−01 | −1.0597E+05 | 5.3874E+05 | −1.9937E+06 | 5.3658E+06 | −1.0380E+07 |
| R7 | 1.1284E+03 | 2.4609E+04 | −9.4179E+04 | 2.6187E+05 | −5.3022E+05 | 7.7372E+05 |
| R8 | 3.9092E+00 | 2.3701E+03 | −4.8087E+03 | 7.1170E+03 | −7.6818E+03 | 5.9762E+03 |
| R9 | −2.1232E+02 | 1.4853E+03 | −2.7788E+03 | 3.8134E+03 | −3.8287E+03 | 2.7758E+03 |
| R10 | −9.1740E−01 | 2.3331E+01 | −2.9420E+01 | 2.7993E+01 | −1.9897E+01 | 1.0310E+01 |
| R11 | −3.7912E+00 | 1.6322E+00 | −1.0442E+00 | 4.7279E−01 | −1.5323E−01 | 3.5389E−02 |
| R12 | −3.5597E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −8.1594E+01 | 0.0000E+00 | 0.0000E+00 | 0.0000E+00 | 0.0000E+00 | / |
| R2 | −1.3339E+01 | 0.0000E+00 | 0.0000E+00 | 0.0000E+00 | 0.0000E+00 | / |
| R3 | −5.1913E+00 | 0.0000E+00 | 0.0000E+00 | 0.0000E+00 | 0.0000E+00 | / |
| R4 | 2.7730E+01 | 6.0255E+07 | −8.0229E+07 | 6.1421E+07 | −2.0459E+07 | / |
| R5 | 2.3628E+01 | −8.6110E+08 | 1.4434E+09 | −1.4204E+09 | 6.2191E+08 | / |
| R6 | 8.6132E−01 | 1.4050E+07 | −1.2621E+07 | 6.7560E+06 | −1.6302E+06 | / |
| R7 | 1.1284E+03 | −7.9249E+05 | 5.4055E+05 | −2.2046E+05 | 4.0667E+04 | / |
| R8 | 3.9092E+00 | −3.2613E+03 | 1.1840E+03 | −2.5673E+02 | 2.5146E+01 | / |
| R9 | −2.1232E+02 | −1.4132E+03 | 4.7905E+02 | −9.7051E+01 | 8.8881E+00 | / |
| R10 | −9.1740E−01 | −3.7552E+00 | 9.0680E−01 | −1.3002E−01 | 8.3666E−03 | / |
| R11 | −3.7912E+00 | −5.6918E−03 | 6.0616E−04 | −3.8426E−05 | 1.0977E−06 | / |
| R12 | −3.5597E+00 | 1.12590−05 | −6.6807E−07 | 2.4495E−08 | −4.2381E−10 | / |

In addition, in the subsequent Table 15, the values corresponding to the parameters specified in the relationship formulas in the second embodiment are also listed.

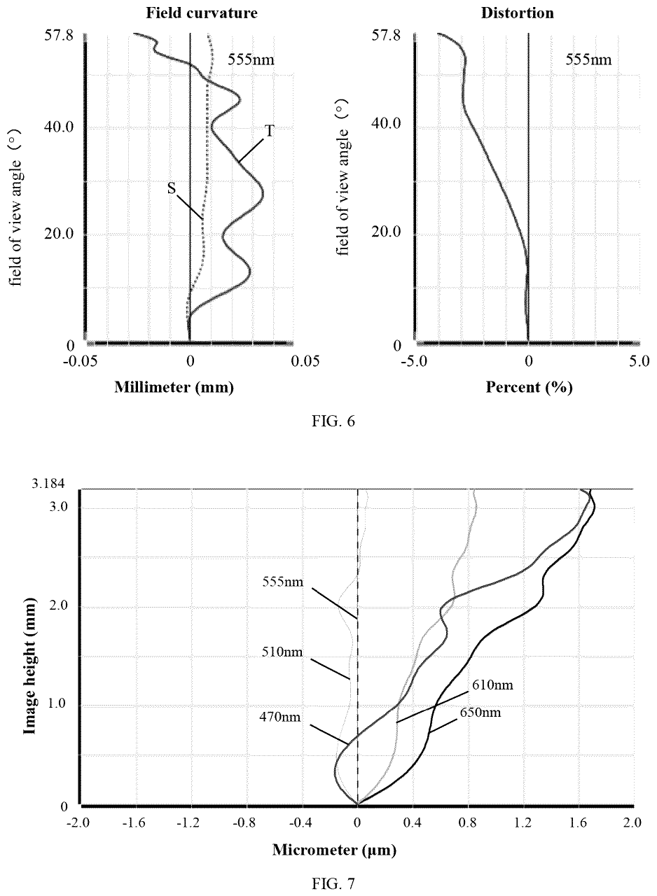

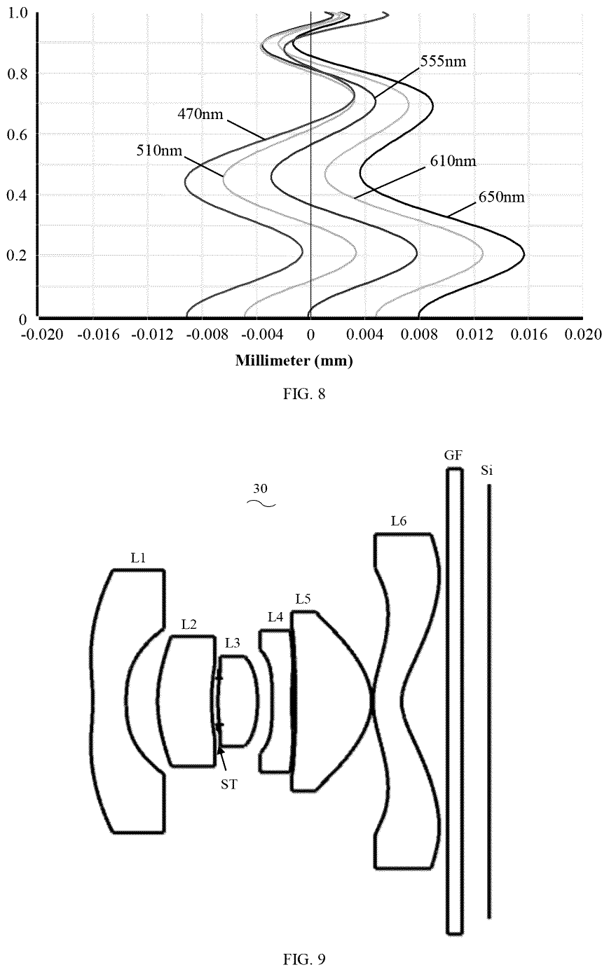

FIG. 6 shows a schematic diagram of field curvature and distortion of light with a wavelength of 555 nanometers after passing through the imaging optical lens 20 of the second embodiment. The field curvature S in FIG. 6 is a field curvature in the sagittal direction, and T is a field curvature in the meridian direction. FIG. 7 shows a schematic diagram of the lateral color of light with wavelengths of 470 nm, 510 nm, 555 nm, 610 nm, and 650 nm after passing through the imaging optical lens 20 of the second embodiment. FIG. 8 shows a schematic diagram of the longitudinal aberration of light with wavelengths of 470 nm, 510 nm, 555 nm, 610 nm, and 650 nm after passing through the imaging optical lens 20 of the second embodiment.

As shown in Table 15, the second embodiment satisfies all relationship formulas.

In this embodiment, the pupil entering diameter (ENPD) of the imaging optical lens 20 is 0.928 mm, the full field-of-view (1.0H) image-height IH is 3.184 mm, and the field of view angle (FOV) of the 1.0 field of view is 115.67°. The imaging optical lens 20 has the characteristics of a large aperture, a wide angle, and ultra-thinness, and its on-axis and off-axis chromatic aberrations are fully corrected, with excellent optical performance.

### Third Embodiment

FIG. 9 is a schematic structural diagram of the imaging optical lens 30 in the third embodiment. The third embodiment is basically the same as the first embodiment, and the meaning of the symbols in the third embodiment is the same as the first embodiment. Only the differences are listed below.

Tables 5 and 6 show the design data of the imaging optical lens 30 in the third embodiment of the present disclosure.

TABLE 5

| | R | D | | nd | | vd | |
|---|---|---|---|---|---|---|---|
| R1 | −2.851 | d1= | 0.495 | nd1 | 1.5444 | νd1 | 55.82 |
| R2 | 2.851 | d2= | 0.468 | | | | |
| R3 | 2.182 | d3= | 0.805 | nd2 | 1.6153 | νd2 | 25.94 |
| R4 | 3.837 | d4= | 0.093 | | | | |
| ST | ∞ | / | / | / | / | / | / |
| R5 | 3.272 | d5= | 0.589 | nd3 | 1.5444 | νd3 | 55.82 |
| R6 | −2.162 | d6= | 0.216 | | | | |
| R7 | −350.349 | d7= | 0.296 | nd4 | 1.6700 | νd4 | 19.39 |
| R8 | 3.916 | d8= | 0.056 | | | | |
| R9 | −31.543 | d9= | 1.136 | nd5 | 1.5444 | νd5 | 55.82 |
| R10 | −0.841 | d10= | 0.020 | | | | |
| R11 | 1.367 | d11= | 0.424 | nd6 | 1.6400 | νd6 | 23.54 |
| R12 | 0.702 | d12= | 0.687 | | | | |
| R13 | ∞ | d13= | 0.210 | ndg1 | 1.5168 | vg1 | 64.17 |
| R14 | ∞ | d14= | 0.408 | | | | |

TABLE 6

| | Conic | | | | | |
|---|---|---|---|---|---|---|
| | coefficient | Aspheric coefficient | | | | |
| | K | A4 | A6 | A8 | A10 | A12 |
| R1 | −4.7613E+01 | 1.8457E−01 | −1.8950E−01 | 1.5954E−01 | −1.0111E−01 | 4.5291E−02 |
| R2 | −2.9589E+00 | 5.2241E−01 | −6.3326E−01 | 7.9836E−01 | −4.4813E−01 | −8.0305E−01 |
| R3 | −4.2290E+00 | 7.9593E−02 | −2.5928E−01 | 8.6637E−01 | −3.0574E+00 | 7.2032E+00 |
| R4 | 2.5478E+01 | −1.0396E−02 | −9.6823E−01 | 1.6171E+01 | −2.0974E+02 | 2.7514E+03 |
| R5 | 9.5231E+00 | −5.5503E−02 | 4.0208E−01 | −2.4229E+01 | 7.0601E+02 | −1.4651E+04 |
| R6 | 8.7973E−02 | −1.3285E−01 | −4.6972E+00 | 1.0451E+02 | −1.5160E+03 | 1.5051E+04 |
| R7 | 1.9000E+05 | −5.4614E−01 | 2.8615E+00 | −5.1164E+01 | 5.9694E+02 | −4.6019E+03 |
| R8 | 1.1572E+00 | −4.5664E−01 | 3.6713E+00 | −3.5050E+01 | 2.1061E+02 | −8.4289E+02 |
| R9 | −1.7788E+02 | −1.6360E−01 | 3.1165E+00 | −2.9384E+01 | 1.5959E+02 | −5.7783E+02 |
| R10 | −9.8071E−01 | 2.8368E−01 | −2.1917E−01 | −1.0970E+00 | 5.5010E+00 | −1.3707E+01 |
| R11 | −3.9271E+00 | −1.3334E−01 | 1.5121E−01 | −5.1593E−01 | 1.2260E+00 | −1.7533E+00 |
| R12 | −3.7223E+00 | −2.9180E−02 | −1.3108E−01 | 2.6824E−01 | −2.7926E−01 | 1.8487E−01 |
| | Conic | | | | | |
| | coefficient | Aspheric coefficient | | | | |
| | K | A14 | A16 | A18 | A20 | A22 |
| R1 | −4.7613E+01 | −1.3698E−02 | 2.6455E−03 | −2.9351E−04 | 1.4192E−05 | 0.0000E+00 |
| R2 | −2.9589E+00 | 1.9352E+00 | −1.7578E+00 | 7.7832E−01 | −1.3804E−01 | 0.0000E+00 |
| R3 | −4.2290E+00 | −1.0460E+01 | 9.1097E+00 | −4.3510E+00 | 8.7268E−01 | 0.0000E+00 |
| R4 | 2.5478E+01 | −3.3261E+04 | 3.0897E+05 | −2.0330E+06 | 9.2622E+06 | −2.8875E+07 |
| R5 | 9.5231E+00 | 2.1552E+05 | −2.2557E+06 | 1.6848E+07 | −8.9565E+07 | 3.3519E+08 |
| R6 | 8.7973E−02 | −1.0597E+05 | 5.3874E+05 | −1.9937E+06 | 5.3658E+06 | −1.0380E+07 |
| R7 | 1.9000E+05 | 2.4608E+04 | −9.4179E+04 | 2.6187E+05 | −5.3022E+05 | 7.7372E+05 |
| R8 | 1.1572E+00 | 2.3701E+03 | −4.8087E+03 | 7.1170E+03 | −7.6818E+03 | 5.9762E+03 |
| R9 | −1.7788E+02 | 1.4853E+03 | −2.7788E+03 | 3.8134E+03 | −3.8287E+03 | 2.7758E+03 |
| R10 | −9.8071E−01 | 2.3332E+01 | −2.9420E+01 | 2.7994E+01 | −1.9897E+01 | 1.0310E+01 |
| R11 | −3.9271E+00 | 1.6322E+00 | −1.0442E+00 | 4.7279E−01 | −1.5323E−01 | 3.5389E−02 |
| R12 | −3.7223E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −4.7613E+01 | 0.0000E+00 | 0.0000E+00 | 0.0000E+00 | 0.0000E+00 | / |
| R2 | −2.9589E+00 | 0.0000E+00 | 0.0000E+00 | 0.0000E+00 | 0.0000E+00 | / |
| R3 | −4.2290E+00 | 0.0000E+00 | 0.0000E+00 | 0.0000E+00 | 0.0000E+00 | / |
| R4 | 2.5478E+01 | 6.0261E+07 | −8.0256E+07 | 6.1453E+07 | −2.0539E+07 | / |
| R5 | 9.5231E+00 | −8.6112E+08 | 1.4434E+09 | −1.4205E+09 | 6.2266E+08 | / |
| R6 | 8.7973E−02 | 1.4050E+07 | −1.2621E+07 | 6.7560E+06 | −1.6303E+06 | / |
| R7 | 1.9000E+05 | −7.9249E+05 | 5.4055E+05 | −2.2046E+05 | 4.0663E+04 | / |
| R8 | 1.1572E+00 | −3.2613E+03 | 1.1840E+03 | −2.5673E+02 | 2.5147E+01 | / |
| R9 | −1.7788E+02 | −1.4132E+03 | 4.7905E+02 | −9.7051E+01 | 8.8882E+00 | / |
| R10 | −9.8071E−01 | −3.7552E+00 | 9.0680E−01 | −1.3002E−01 | 8.3681E−03 | / |
| R11 | −3.9271E+00 | −5.6918E−03 | 6.0616E−04 | −3.8425E−05 | 1.0975E−06 | / |
| R12 | −3.7223E+00 | 1.1258E−05 | −6.6808E−07 | 2.4495E−08 | −4.2365E−10 | / |

In addition, in the subsequent Table 15, the values corresponding to the parameters specified in the relationship formulas in the third embodiment are also listed.

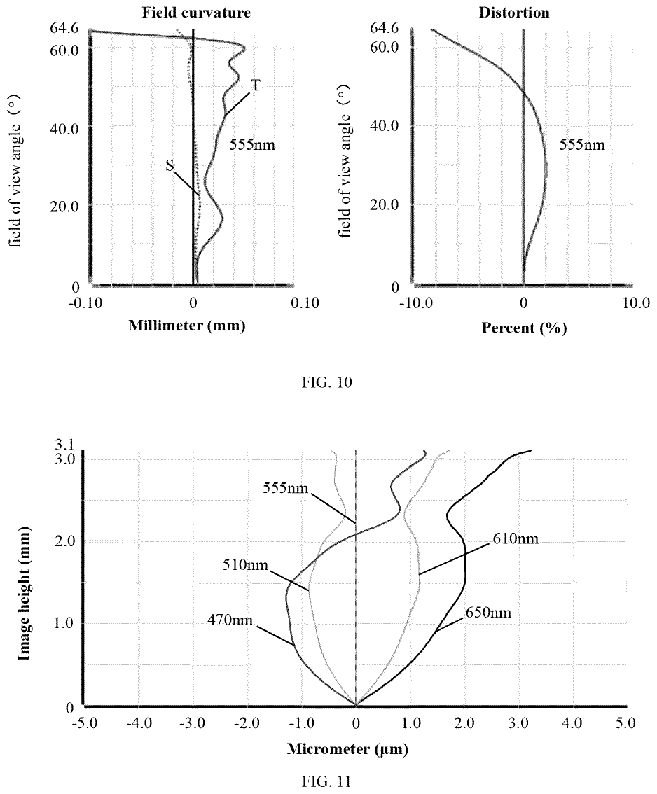

FIG. 10 shows a schematic diagram of the field curvature and distortion of light with a wavelength of 555 nm after passing through the microscope objective lens 30 of the third embodiment. The field curvature S in FIG. 10 is a field curvature in the sagittal direction, and T is a field curvature in the meridian direction. FIG. 11 shows a schematic diagram of the lateral color of light with wavelengths of 470 nm, 510 nm, 555 nm, 610 nm, and 650 nm after passing through the imaging optical lens 30 of the third embodiment. FIG. 12 shows a schematic diagram of the longitudinal aberration of light with wavelengths of 470 nm, 510 nm, 555 nm, 610 nm, and 650 nm after passing through the imaging optical lens 30 of the third embodiment.

As shown in Table 15, the third embodiment satisfies all relationship formulas.

In this embodiment, the pupil entering diameter (ENPD) of the imaging optical lens 30 is 0.716 mm, the full field-of-view (1.0H) image-height IH is 3.100 mm, and the field of view angle (FOV) of the 1.0 field of view is 129.20°. The imaging optical lens 30 has the characteristics of a large aperture, a wide angle, and ultra-thinness, and its on-axis and off-axis chromatic aberrations are fully corrected, with excellent optical performance.

### Fourth Embodiment

FIG. 13 is a schematic structural diagram of the imaging optical lens 40 in the fourth embodiment. The fourth embodiment is basically the same as the first embodiment, and the meaning of the symbols in the fourth embodiment is the same as the first embodiment. Only the differences are listed below.

Tables 7 and 8 show the design data of the imaging optical lens 40 in the fourth embodiment of the present disclosure.

TABLE 7

| | R | D | | nd | | vd | |
|---|---|---|---|---|---|---|---|
| R1 | −2.748 | d1= | 0.297 | nd1 | 1.5444 | νd1 | 55.82 |
| R2 | 6.409 | d2= | 0.174 | | | | |
| R3 | 1.940 | d3= | 0.593 | nd2 | 1.6153 | νd2 | 25.94 |
| R4 | 3.497 | d4= | 0.050 | | | | |
| ST | ∞ | / | / | / | / | / | |
| R5 | 3.298 | d5= | 0.469 | nd3 | 1.5444 | νd3 | 55.82 |
| R6 | −2.833 | d6= | 0.231 | | | | |
| R7 | −55.306 | d7= | 0.297 | nd4 | 1.6700 | νd4 | 19.39 |
| R8 | 4.013 | d8= | 0.081 | | | | |
| R9 | −9.734 | d9= | 1.084 | nd5 | 1.5444 | νd5 | 55.82 |
| R10 | −0.875 | d10= | 0.173 | | | | |
| R11 | 1.465 | d11= | 0.376 | nd6 | 1.6400 | νd6 | 23.54 |
| R12 | 0.705 | d12= | 1.182 | | | | |
| R13 | ∞ | d13= | 0.210 | ndg1 | 1.5168 | vg1 | 64.17 |
| R14 | ∞ | d14= | 0.106 | | | | |

TABLE 8

| | Conic | | | | | |
|---|---|---|---|---|---|---|
| | coefficient | Aspheric coefficient | | | | |
| | K | A4 | A6 | A8 | A10 | A12 |
| R1 | −4.3861E+01 | 1.8067E−01 | −1.9161E−01 | 1.5854E−01 | −1.0174E−01 | 4.5422E−02 |
| R2 | −3.5493E+01 | 4.4110E−01 | −6.7562E−01 | 7.4908E−01 | −4.2090E−01 | −8.0624E−01 |
| R3 | −6.7356E+00 | 5.2500E−02 | −2.7854E−01 | 8.6574E−01 | −3.0990E+00 | 7.1941E+00 |
| R4 | 2.6338E+01 | 1.0380E−02 | −1.0436E+00 | 1.6047E+01 | −2.0938E+02 | 2.7526E+03 |
| R5 | 1.7586E+01 | −7.9687E−03 | 3.6435E−01 | −2.3522E+01 | 7.0471E+02 | −1.4654E+04 |
| R6 | −4.3133E+00 | −1.0221E−01 | −4.5705E+00 | 1.0452E+02 | −1.5164E+03 | 1.5050E+04 |
| R7 | 4.7085E+03 | −4.2417E−01 | 2.8901E+00 | −5.1037E+01 | 5.9708E+02 | −4.6019E+03 |
| R8 | 7.7975E−01 | −4.6197E−01 | 3.6821E+00 | −3.5034E+01 | 2.1062E+02 | −8.4289E+02 |
| R9 | −1.3161E+01 | −1.4989E−01 | 3.1301E+00 | −2.9377E+01 | 1.5960E+02 | −5.7783E+02 |
| R10 | −1.0556E+00 | 3.0466E−01 | −2.1727E−01 | −1.0800E+00 | 5.4996E+00 | −1.3707E+01 |
| R11 | −4.2597E+00 | −1.1442E−01 | 1.4826E−01 | −5.1687E−01 | 1.2261E+00 | −1.7533E+00 |
| R12 | −3.8276E+00 | −2.3909E−02 | −1.3257E−01 | 2.6813E−01 | −2.7921E−01 | 1.8487E−01 |
| | Conic | | | | | |
| | coefficient | Aspheric coefficient | | | | |
| | K | A14 | A16 | A18 | A20 | A22 |
| R1 | −4.3861E+01 | −1.3707E−02 | 2.6402E−03 | −3.2468E−04 | 3.4438E−05 | 0.0000E+00 |
| R2 | −3.5493E+01 | 1.9341E+00 | −1.7546E+00 | 7.7822E−01 | −1.3598E−01 | 0.0000E+00 |
| R3 | −6.7356E+00 | −1.0436E+01 | 9.1595E+00 | −4.3087E+00 | 8.1287E−01 | 0.0000E+00 |
| R4 | 2.6338E+01 | −3.3255E+04 | 3.0895E+05 | −2.0330E+06 | 9.2617E+06 | −2.8875E+07 |
| R5 | 1.7586E+01 | 2.1550E+05 | −2.2557E+06 | 1.6848E+07 | −8.9564E+07 | 3.3519E+08 |
| R6 | −4.3133E+00 | −1.0597E+05 | 5.3874E+05 | −1.9937E+06 | 5.3658E+06 | −1.0380E+07 |
| R7 | 4.7085E+03 | 2.4608E+04 | −9.4179E+04 | 2.6187E+05 | −5.3022E+05 | 7.7372E+05 |
| R8 | 7.7975E−01 | 2.3701E+03 | −4.8087E+03 | 7.1170E+03 | −7.6818E+03 | 5.9762E+03 |
| R9 | −1.3161E+01 | 1.4853E+03 | −2.7788E+03 | 3.8134E+03 | −3.8287E+03 | 2.7758E+03 |
| R10 | −1.0556E+00 | 2.3331E+01 | −2.9421E+01 | 2.7994E+01 | −1.9897E+01 | 1.0310E+01 |
| R11 | −4.2597E+00 | 1.6322E+00 | −1.0442E+00 | 4.7279E−01 | −1.5324E−01 | 3.5389E−02 |
| R12 | −3.8276E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −4.3861E+01 | 0.0000E+00 | 0.0000E+00 | 0.0000E+00 | 0.0000E+00 | / |
| R2 | −3.5493E+01 | 0.0000E+00 | 0.0000E+00 | 0.0000E+00 | 0.0000E+00 | / |
| R3 | −6.7356E+00 | 0.0000E+00 | 0.0000E+00 | 0.0000E+00 | 0.0000E+00 | / |
| R4 | 2.6338E+01 | 6.0262E+07 | −8.0254E+07 | 6.1457E+07 | −2.0514E+07 | / |
| R5 | 1.7586E+01 | −8.6111E+08 | 1.4434E+09 | −1.4204E+09 | 6.2189E+08 | / |
| R6 | −4.3133E+00 | 1.4050E+07 | −1.2621E+07 | 6.7560E+06 | −1.6303E+06 | / |
| R7 | 4.7085E+03 | −7.9249E+05 | 5.4055E+05 | −2.2046E+05 | 4.0664E+04 | / |
| R8 | 7.7975E−01 | −3.2613E+03 | 1.1840E+03 | −2.5673E+02 | 2.5147E+01 | / |
| R9 | −1.3161E+01 | −1.4132E+03 | 4.7905E+02 | −9.7051E+01 | 8.8882E+00 | / |
| R10 | −1.0556E+00 | −3.7552E+00 | 9.0680E−01 | −1.3002E−01 | 8.3683E−03 | / |
| R11 | −4.2597E+00 | −5.6918E−03 | 6.0616E−04 | −3.8425E−05 | 1.0976E−06 | / |
| R12 | −3.8276E+00 | 1.1258E−05 | −6.6808E−07 | 2.4497E−08 | −4.2385E−10 | / |

In addition, the subsequent Table 15 also lists the values corresponding to the parameters specified in the relationship formulas in the fourth embodiment.

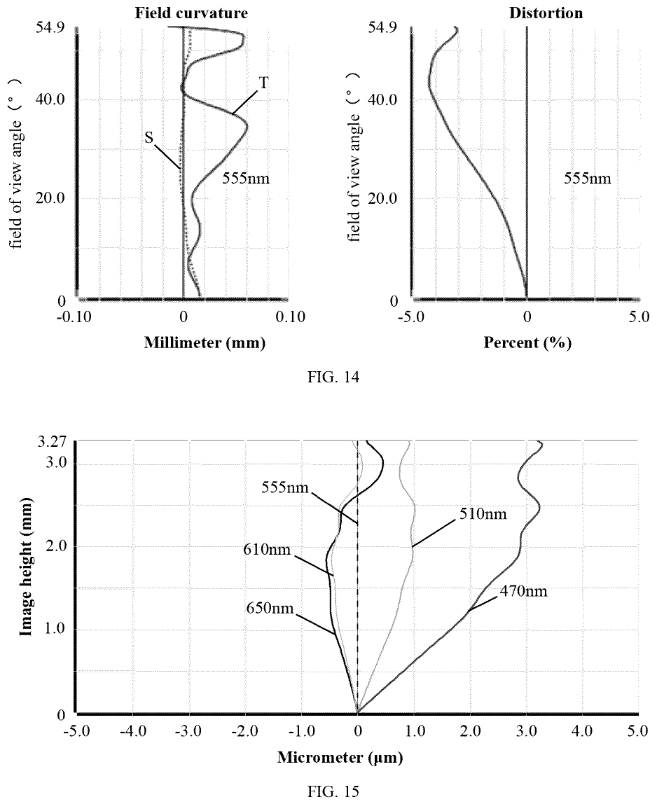

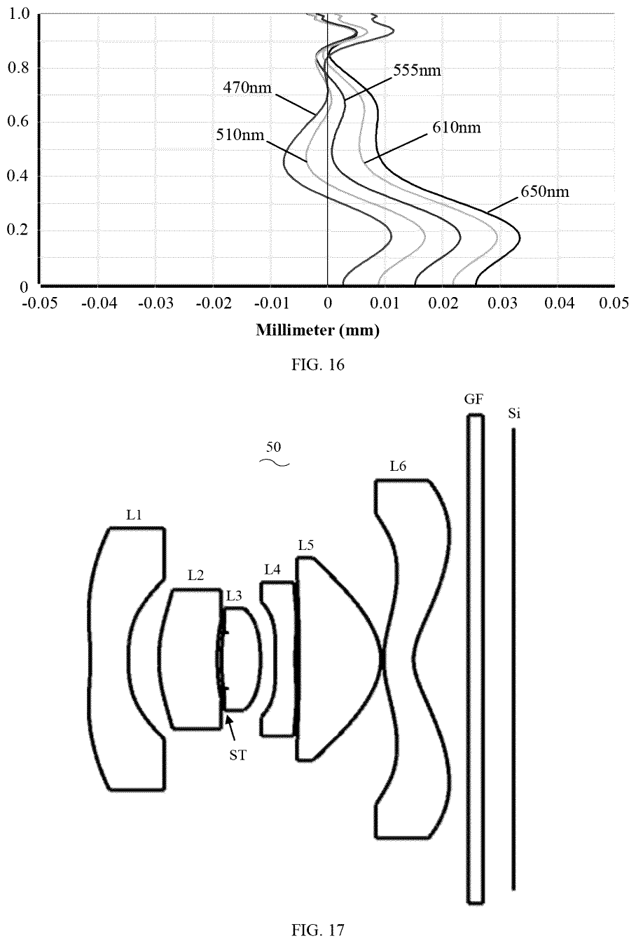

FIG. 14 shows a schematic diagram of field curvature and distortion of light with a wavelength of 555 nanometers after passing through the imaging optical lens 40 of the fourth embodiment. The field curvature S in FIG. 14 is a field curvature in the sagittal direction, and T is a field curvature in the meridian direction. FIG. 15 shows a schematic diagram of the lateral color of light with wavelengths of 470 nm, 510 nm, 555 nm, 610 nm, and 650 nm after passing through the imaging optical lens 40 of the fourth embodiment. FIG. 16 shows a schematic diagram of longitudinal aberration of light with wavelengths of 470 nm, 510 nm, 555 nm, 610 nm, and 650 nm after passing through the imaging optical lens 40 of the fourth embodiment.

As shown in Table 15, the fourth embodiment satisfies each relationship formula.

In this embodiment, the pupil entering diameter (ENPD) of the imaging optical lens 40 is 1.060 mm, the full field-of-view (1.0H) image-height IH is 3.269 mm, and the field of view angle (FOV) of the 1.0 field of view is 109.77°. The imaging optical lens 40 has the characteristics of a large aperture, a wide angle, and ultra-thinness, and its on-axis and off-axis chromatic aberrations are fully corrected, with excellent optical performance.

### Fifth Embodiment

FIG. 17 is a schematic structural diagram of the imaging optical lens 50 in the fifth embodiment. The fifth embodiment is basically the same as the first embodiment, and the meanings of the symbols in the Fifth embodiment is the same as the first embodiment. Only the differences are listed below.

Tables 9 and 10 show the design data of the imaging optical lens 50 in the fifth embodiment of the present disclosure.

TABLE 9

| | R | D | | nd | | vd | |
|---|---|---|---|---|---|---|---|
| R1 | −3.300 | d1= | 0.532 | nd1 | 1.5444 | νd1 | 55.82 |
| R2 | 3.315 | d2= | 0.431 | | | | |
| R3 | 2.171 | d3= | 0.824 | nd2 | 1.6153 | νd2 | 25.94 |
| R4 | 3.648 | d4= | 0.060 | | | | |
| ST | ∞ | / | / | / | / | / | / |
| R5 | 4.001 | d5= | 0.548 | nd3 | 1.5444 | νd3 | 55.82 |
| R6 | −2.408 | d6= | 0.212 | | | | |
| R7 | −157.068 | d7= | 0.277 | nd4 | 1.6700 | νd4 | 19.39 |
| R8 | 3.983 | d8= | 0.051 | | | | |
| R9 | −413.216 | d9= | 1.160 | nd5 | 1.5444 | vd5 | 55.82 |
| R10 | −0.817 | d10= | 0.041 | | | | |
| R11 | 1.512 | d11= | 0.420 | nd6 | 1.6400 | νd6 | 23.54 |
| R12 | 0.718 | d12= | 0.768 | | | | |
| R13 | ∞ | d13= | 0.210 | ndg1 | 1.5168 | vg1 | 64.17 |
| R14 | ∞ | d14= | 0.434 | | | | |

TABLE 10

| | Conic | | | | | |
|---|---|---|---|---|---|---|
| | coefficient | Aspheric coefficient | | | | |
| | K | A4 | A6 | A8 | A10 | A12 |
| R1 | −4.4295E+01 | 1.8549E−01 | −1.8939E−01 | 1.5954E−01 | −1.0111E−01 | 4.5291E−02 |
| R2 | −9.9109E+00 | 5.0668E−01 | −6.3818E−01 | 7.9569E−01 | −4.4923E−01 | −8.0393E−01 |
| R3 | −3.6051E+00 | 7.8123E−02 | −2.6978E−01 | 8.5950E−01 | −3.0589E+00 | 7.2035E+00 |
| R4 | 2.8238E+01 | 2.3150E−02 | −1.1183E+00 | 1.6158E+01 | −2.0917E+02 | 2.7526E+03 |
| R5 | 1.1697E+01 | −2.8334E−02 | 4.6052E−01 | −2.4167E+01 | 7.0658E+02 | −1.4655E+04 |
| R6 | −2.1459E−02 | −1.3313E−01 | −4.6690E+00 | 1.0450E+02 | −1.5162E+03 | 1.5051E+04 |
| R7 | 6.4918E+02 | −5.2230E−01 | 2.8547E+00 | −5.1141E+01 | 5.9693E+02 | −4.6019E+03 |
| R8 | 5.6825E−01 | −4.5912E−01 | 3.6703E+00 | −3.5049E+01 | 2.1061E+02 | −8.4289E+02 |
| R9 | −8.7215E+02 | −1.6433E−01 | 3.1181E+00 | −2.9383E+01 | 1.5960E+02 | −5.7783E+02 |
| R10 | −9.9016E−01 | 2.9262E−01 | −2.1894E−01 | −1.0972E+00 | 5.5010E+00 | −1.3707E+01 |
| R11 | −4.4065E+00 | −1.3321E−01 | 1.5109E−01 | −5.1594E−01 | 1.2260E+00 | −1.7533E+00 |
| R12 | −3.9314E+00 | −3.1284E−02 | −1.3112E−01 | 2.6824E−01 | −2.7926E−01 | 1.8487E−01 |
| | Conic | | | | | |
| | coefficient | Aspheric coefficient | | | | |
| | K | A14 | A16 | A18 | A20 | A22 |
| R1 | −4.4295E+01 | −1.3699E−02 | 2.6455E−03 | −2.9351E−04 | 1.4194E−05 | 0.0000E+00 |
| R2 | −9.9109E+00 | 1.9349E+00 | −1.7582E+00 | 7.7792E−01 | −1.3844E−01 | 0.0000E+00 |
| R3 | −3.6051E+00 | −1.0457E+01 | 9.1108E+00 | −4.3512E+00 | 8.7124E−01 | 0.0000E+00 |
| R4 | 2.8238E+01 | −3.3257E+04 | 3.0897E+05 | −2.0330E+06 | 9.2621E+06 | −2.8875E+07 |
| R5 | 1.1697E+01 | 2.1550E+05 | −2.2557E+06 | 1.6848E+07 | −8.9565E+07 | 3.3519E+08 |
| R6 | −2.1459E−02 | −1.0597E+05 | 5.3875E+05 | −1.9937E+06 | 5.3658E+06 | −1.0380E+07 |
| R7 | 6.4918E+02 | 2.4608E+04 | −9.4179E+04 | 2.6187E+05 | −5.3022E+05 | 7.7372E+05 |
| R8 | 5.6825E−01 | 2.3701E+03 | −4.8087E+03 | 7.1170E+03 | −7.6818E+03 | 5.9762E+03 |
| R9 | −8.7215E+02 | 1.4853E+03 | −2.7788E+03 | 3.8134E+03 | −3.8287E+03 | 2.7758E+03 |
| R10 | −9.9016E−01 | 2.3331E+01 | −2.9420E+01 | 2.7994E+01 | −1.9897E+01 | 1.0310E+01 |
| R11 | −4.4065E+00 | 1.6322E+00 | −1.0442E+00 | 4.7279E−01 | −1.5323E−01 | 3.5389E−02 |
| R12 | −3.9314E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −4.4295E+01 | 0.0000E+00 | 0.0000E+00 | 0.0000E+00 | 0.0000E+00 | / |
| R2 | −9.9109E+00 | 0.0000E+00 | 0.0000E+00 | 0.0000E+00 | 0.0000E+00 | / |
| R3 | −3.6051E+00 | 0.0000E+00 | 0.0000E+00 | 0.0000E+00 | 0.0000E+00 | / |
| R4 | 2.8238E+01 | 6.0261E+07 | −8.0256E+07 | 6.1458E+07 | −2.0529E+07 | / |
| R5 | 1.1697E+01 | −8.6113E+08 | 1.4435E+09 | −1.4205E+09 | 6.2225E+08 | / |
| R6 | −2.1459E−02 | 1.4050E+07 | −1.2621E+07 | 6.7561E+06 | −1.6303E+06 | / |
| R7 | 6.4918E+02 | −7.9249E+05 | 5.4055E+05 | −2.2046E+05 | 4.0663E+04 | / |
| R8 | 5.6825E−01 | −3.2613E+03 | 1.1840E+03 | −2.5673E+02 | 2.5147E+01 | / |
| R9 | −8.7215E+02 | −1.4132E+03 | 4.7905E+02 | −9.7051E+01 | 8.8883E+00 | / |
| R10 | −9.9016E−01 | −3.7552E+00 | 9.0680E−01 | −1.3002E−01 | 8.3678E−03 | / |
| R11 | −4.4065E+00 | −5.6918E−03 | 6.0616E−04 | −3.8425E−05 | 1.0975E−06 | / |
| R12 | −3.9314E+00 | 1.1258E−05 | −6.6808E−07 | 2.4495E−08 | −4.2365E−10 | / |

In addition, the subsequent Table 15 also lists the values corresponding to the parameters specified in the relationship formulas in the fifth embodiment of the present disclosure.

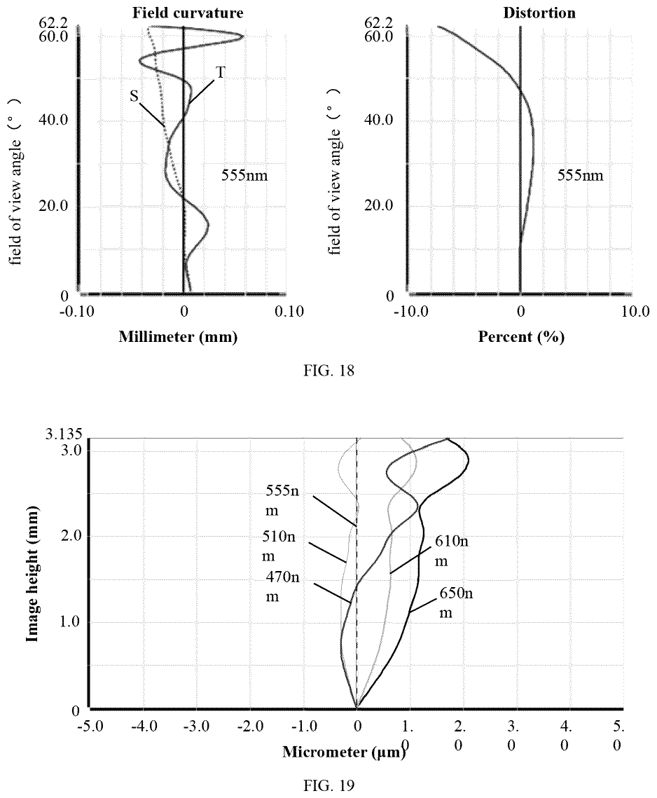

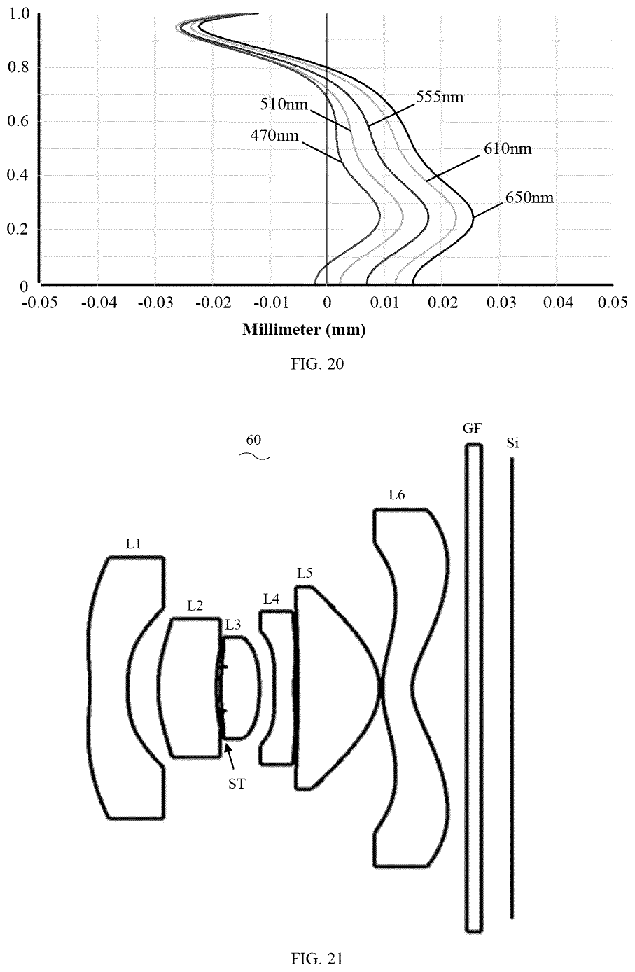

FIG. 18 shows a schematic diagram of field curvature and distortion of light with a wavelength of 555 nanometers after passing through the imaging optical lens 50 of the fifth embodiment. The field curvature S in FIG. 18 is a field curvature in the sagittal direction, and T is a field curvature in the meridian direction. FIG. 19 shows a schematic diagram of lateral chromatic aberration of light with wavelengths of 470 nm, 510 nm, 555 nm, 610 nm, and 650 nm after passing through the imaging optical lens 50 of the fifth embodiment. FIG. 20 shows a schematic diagram of axial aberration of light with wavelengths of 470 nm, 510 nm, 555 nm, 610 nm, and 650 nm after passing through the imaging optical lens 50 of the fifth embodiment.

As shown in Table 15, the fifth embodiment satisfies all relationship formulas.

In this embodiment, the pupil entering diameter (ENPD) of the imaging optical lens 50 is 0.796 mm, the full field-of-view (1.0H) image-height IH is 3.268 mm, and the field of view angle (FOV) of the 1.0 field of view is 124.37°. The imaging optical lens 50 has the characteristics of a large aperture, a wide angle, and ultra-thinness, and its on-axis and off-axis chromatic aberrations are fully corrected, with excellent optical performance.

### Sixth Embodiment

FIG. 21 is a schematic structural diagram of the imaging optical lens 60 in the sixth embodiment. The sixth embodiment is basically the same as the first embodiment, and the meanings of the symbols are the same as those in the first embodiment. Only the differences are listed below.

Tables 11 and 12 show the design data of the imaging optical lens 60 in the sixth embodiment of the present disclosure.

TABLE 11

| | R | D | | nd | | vd | |
|---|---|---|---|---|---|---|---|
| R1 | −3.307 | d1= | 0.438 | nd1 | 1.5444 | νd1 | 55.82 |
| R2 | 3.307 | d2= | 0.327 | | | | |
| R3 | 1.976 | d3= | 0.650 | nd2 | 1.6153 | νd2 | 25.94 |
| R4 | 5.788 | d4= | 0.079 | | | | |
| ST | ∞ | / | / | / | / | / | / |
| R5 | 5.731 | d5= | 0.662 | nd3 | 1.5444 | νd3 | 55.82 |
| R6 | −3.093 | d6= | 0.172 | | | | |
| R7 | −134.029 | d7= | 0.331 | nd4 | 1.6700 | νd4 | 19.39 |
| R8 | 3.818 | d8= | 0.060 | | | | |
| R9 | −33.059 | d9= | 1.245 | nd5 | 1.5444 | νd5 | 55.82 |
| R10 | −0.853 | d10= | 0.020 | | | | |
| R11 | 1.594 | d11= | 0.480 | nd6 | 1.6400 | νd6 | 23.54 |
| R12 | 0.749 | d12= | 0.863 | | | | |
| R13 | ∞ | d13= | 0.210 | ndg1 | 1.5168 | vg1 | 64.17 |
| R14 | ∞ | d14= | 0.521 | | | | |

TABLE 12

| | Conic | | | | | |
|---|---|---|---|---|---|---|
| | coefficient | Aspheric coefficient | | | | |
| | K | A4 | A6 | A8 | A10 | A12 |
| R1 | −4.9952E+01 | 1.8451E−01 | −1.8935E−01 | 1.5961E−01 | −1.0107E−01 | 4.5298E−02 |
| R2 | −1.0399E+01 | 4.9713E−01 | −6.4551E−01 | 7.9369E−01 | −4.4797E−01 | −8.0269E−01 |
| R3 | −3.8035E+00 | 8.2082E−02 | −2.5265E−01 | 8.5809E−01 | −3.0754E+00 | 7.1950E+00 |
| R4 | 4.8477E+01 | 1.0844E−01 | −9.9428E−01 | 1.6232E+01 | −2.0958E+02 | 2.7513E+03 |
| R5 | 5.0430E+01 | 7.3877E−02 | 5.7898E−01 | −2.4081E+01 | 7.0560E+02 | −1.4655E+04 |
| R6 | 1.4581E+00 | −1.2431E−01 | −4.5895E+00 | 1.0460E+02 | −1.5162E+03 | 1.5050E+04 |
| R7 | 2.7422E+04 | −5.4165E−01 | 2.8718E+00 | −5.1154E+01 | 5.9690E+02 | −4.6019E+03 |
| R8 | 4.6115E−01 | −4.5913E−01 | 3.6722E+00 | −3.5047E+01 | 2.1061E+02 | −8.4289E+02 |
| R9 | −2.3999E+03 | −1.6068E−01 | 3.1176E+00 | −2.9383E+01 | 1.5960E+02 | −5.7783E+02 |
| R10 | −9.7856E−01 | 2.8504E−01 | −2.1978E−01 | −1.0968E+00 | 5.5011E+00 | −1.3707E+01 |
| R11 | −4.1952E+00 | −1.3228E−01 | 1.5113E−01 | −5.1596E−01 | 1.2260E+00 | −1.7533E+00 |
| R12 | −4.3320E+00 | −3.1257E−02 | −1.3106E−01 | 2.6824E−01 | −2.7926E−01 | 1.8487E−01 |
| | Conic | | | | | |
| | coefficient | Aspheric coefficient | | | | |
| | K | A14 | A16 | A18 | A20 | A22 |
| R1 | −4.9952E+01 | −1.3699E−02 | 2.6444E−03 | −2.9375E−04 | 1.4291E−05 | 0.0000E+00 |
| R2 | −1.0399E+01 | 1.9358E+00 | −1.7583E+00 | 7.7762E−01 | −1.3825E−01 | 0.0000E+00 |
| R3 | −3.8035E+00 | −1.0454E+01 | 9.1209E+00 | −4.3461E+00 | 8.6353E−01 | 0.0000E+00 |
| R4 | 4.8477E+01 | −3.3260E+04 | 3.0897E+05 | −2.0330E+06 | 9.2621E+06 | −2.8875E+07 |
| R5 | 5.0430E+01 | 2.1550E+05 | −2.2557E+06 | 1.6848E+07 | −8.9564E+07 | 3.3519E+08 |
| R6 | 1.4581E+00 | −1.0597E+05 | 5.3874E+05 | −1.9937E+06 | 5.3658E+06 | −1.0380E+07 |
| R7 | 2.7422E+04 | 2.4608E+04 | −9.4179E+04 | 2.6187E+05 | −5.3022E+05 | 7.7372E+05 |
| R8 | 4.6115E−01 | 2.3701E+03 | −4.8087E+03 | 7.1170E+03 | −7.6818E+03 | 5.9762E+03 |
| R9 | −2.3999E+03 | 1.4853E+03 | −2.7788E+03 | 3.8134E+03 | −3.8287E+03 | 2.7758E+03 |
| R10 | −9.7856E−01 | 2.3331E+01 | −2.9420E+01 | 2.7994E+01 | −1.9897E+01 | 1.0310E+01 |
| R11 | −4.1952E+00 | 1.6322E+00 | −1.0442E+00 | 4.7279E−01 | −1.5323E−01 | 3.5389E−02 |
| R12 | −4.3320E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −4.9952E+01 | 0.0000E+00 | 0.0000E+00 | 0.0000E+00 | 0.0000E+00 | / |
| R2 | −1.0399E+01 | 0.0000E+00 | 0.0000E+00 | 0.0000E+00 | 0.0000E+00 | / |
| R3 | −3.8035E+00 | 0.0000E+00 | 0.0000E+00 | 0.0000E+00 | 0.0000E+00 | / |
| R4 | 4.8477E+01 | 6.0261E+07 | −8.0255E+07 | 6.1459E+07 | −2.0513E+07 | / |
| R5 | 5.0430E+01 | −8.6111E+08 | 1.4434E+09 | −1.4204E+09 | 6.2191E+08 | / |
| R6 | 1.4581E+00 | 1.4050E+07 | −1.2621E+07 | 6.7561E+06 | −1.6302E+06 | / |
| R7 | 2.7422E+04 | −7.9249E+05 | 5.4055E+05 | −2.2046E+05 | 4.0662E+04 | / |
| R8 | 4.6115E−01 | −3.2613E+03 | 1.1840E+03 | −2.5673E+02 | 2.5147E+01 | / |
| R9 | −2.3999E+03 | −1.4132E+03 | 4.7905E+02 | −9.7051E+01 | 8.8883E+00 | / |
| R10 | −9.7856E−01 | −3.7552E+00 | 9.0680E−01 | −1.3002E−01 | 8.3680E−03 | / |
| R11 | −4.1952E+00 | −5.6918E−03 | 6.0616E−04 | −3.8425E−05 | 1.0975E−06 | / |
| R12 | −4.3320E+00 | 1.1258E−05 | −6.6808E−07 | 2.4495E−08 | −4.2365E−10 | / |

In addition, in the subsequent Table 15, the values corresponding to the parameters specified in the relationship formulas in the sixth embodiment are also listed.

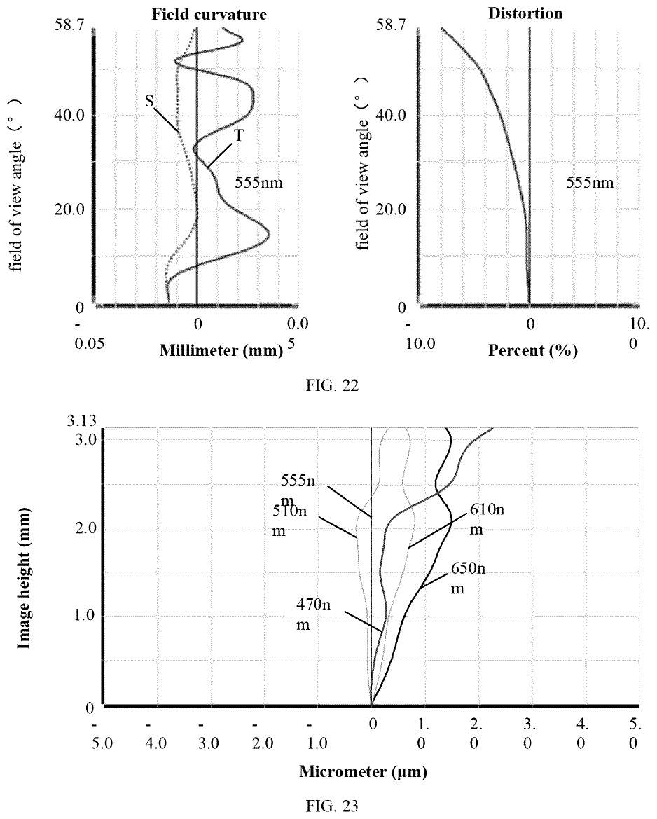

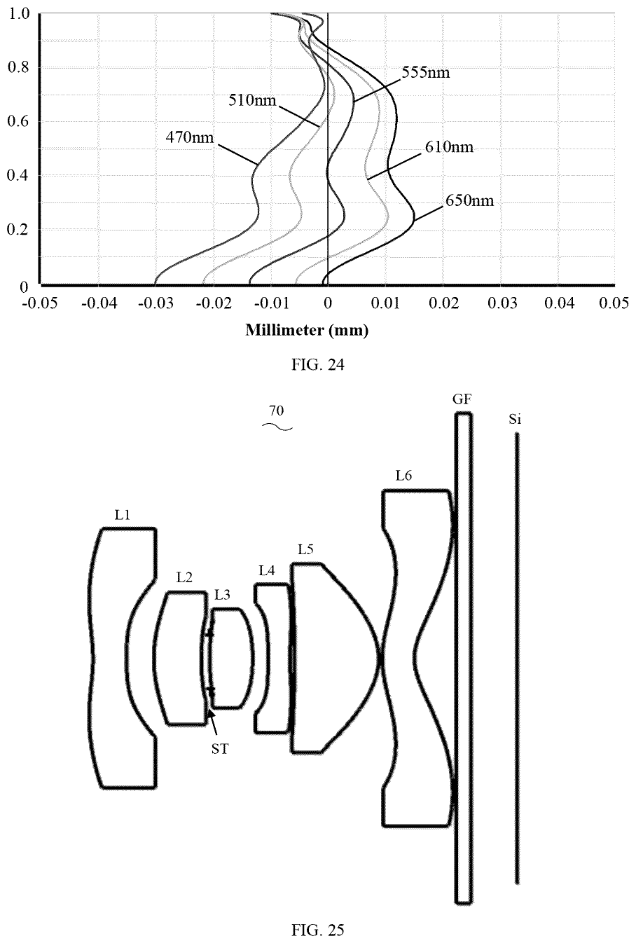

FIG. 22 shows a schematic diagram of field curvature and distortion of light with a wavelength of 555 nanometers after passing through the imaging optical lens 60 of the sixth embodiment. The field curvature S in FIG. 22 is a field curvature in the sagittal direction, and T is a field curvature in the meridian direction. FIG. 23 shows a schematic diagram of the lateral color of light with wavelengths of 470 nm, 510 nm, 555 nm, 610 nm, and 650 nm after passing through the imaging optical lens 60 of the sixth embodiment. FIG. 24 shows a schematic diagram of the longitudinal aberration of light with wavelengths of 470 nm, 510 nm, 555 nm, 610 nm, and 650 nm after passing through the imaging optical lens 60 of the sixth embodiment.

As shown in Table 15, the sixth embodiment satisfies each relationship formula.

In this embodiment, the pupil entering diameter (ENPD) of the microscope objective lens 60 is 0.918 mm, the full field-of-view (1.0H) image-height IH is 3.131 mm, and the field of view angle (FOV) of the 1.0 field of view is 117.33°. The imaging optical lens 60 has the characteristics of a large aperture, a wide angle, and ultra-thinness, and its on-axis and off-axis chromatic aberrations are fully corrected, with excellent optical performance.

### Comparative Embodiment

FIG. 25 is a schematic structural diagram of the imaging optical lens 70 in the comparative embodiment. The meanings of the symbols in the comparative embodiment is the same as the first embodiment. Only the differences are listed below.

Tables 13 and 14 show the design data of the imaging optical lens 70 in the comparative embodiment.

TABLE 13

| | R | D | | nd | | vd | |
|---|---|---|---|---|---|---|---|
| R1 | −2.304 | d1= | 0.471 | nd1 | 1.5444 | νd1 | 55.82 |
| R2 | 6.386 | d2= | 0.383 | | | | |
| R3 | 2.121 | d3= | 0.666 | nd2 | 1.6153 | νd2 | 25.94 |
| R4 | 3.869 | d4= | 0.118 | | | | |
| ST | ∞ | / | / | / | / | / | / |
| R5 | 3.894 | d5= | 0.602 | nd3 | 1.5444 | νd3 | 55.82 |
| R6 | −2.478 | d6= | 0.215 | | | | |
| R7 | −213.053 | d7= | 0.308 | nd4 | 1.6700 | νd4 | 19.39 |
| R8 | 3.804 | d8= | 0.063 | | | | |
| R9 | −44.071 | d9= | 1.187 | nd5 | 1.5444 | νd5 | 55.82 |
| R10 | −0.868 | d10= | 0.050 | | | | |
| R11 | 1.482 | d11= | 0.450 | nd6 | 1.6400 | νd6 | 23.54 |
| R12 | 0.707 | d12= | 0.589 | | | | |
| R13 | ∞ | d13= | 0.210 | ndg1 | 1.5168 | vg1 | 64.17 |
| R14 | ∞ | d14= | 0.646 | | | | |

TABLE 14

| | Conic | | | | | |
|---|---|---|---|---|---|---|
| | coefficient | Aspheric coefficient | | | | |
| | K | A4 | A6 | A8 | A10 | A12 |
| R1 | −2.1762E+01 | 1.8191E−01 | −1.8947E−01 | 1.5965E−01 | −1.0109E−01 | 4.5292E−02 |
| R2 | −6.5191E+00 | 4.9453E−01 | −6.4739E−01 | 8.0117E−01 | −4.4692E−01 | −8.0184E−01 |
| R3 | −3.5763E+00 | 8.2160E−02 | −2.6189E−01 | 8.6335E−01 | −3.0649E+00 | 7.2009E+00 |
| R4 | 3.0106E+01 | 4.5329E−02 | −1.0743E+00 | 1.6152E+01 | −2.0947E+02 | 2.7520E+03 |
| R5 | 1.7483E+01 | −7.0686E−03 | 5.4182E−01 | −2.4092E+01 | 7.0561E+02 | −1.4654E+04 |
| R6 | −1.8747E−01 | −1.2312E−01 | −4.6280E+00 | 1.0464E+02 | −1.5161E+03 | 1.5051E+04 |
| R7 | 7.0886E+04 | −5.3123E−01 | 2.8755E+00 | −5.1154E+01 | 5.9697E+02 | −4.6018E+03 |
| R8 | 6.3905E−01 | −4.5876E−01 | 3.6714E+00 | −3.5048E+01 | 2.1061E+02 | −8.4289E+02 |
| R9 | −1.5482E+03 | −1.6000E−01 | 3.1167E+00 | −2.9385E+01 | 1.5960E+02 | −5.7783E+02 |
| R10 | −9.6828E−01 | 2.8333E−01 | −2.2020E−01 | −1.0959E+00 | 5.5013E+00 | −1.3707E+01 |
| R11 | −4.2660E+00 | −1.3550E−01 | 1.5100E−01 | −5.1596E−01 | 1.2261E+00 | −1.7533E+00 |
| R12 | −3.8771E+00 | −2.9272E−02 | −1.3125E−01 | 2.6820E−01 | −2.7923E−01 | 1.8487E−01 |
| | Conic | | | | | |
| | coefficient | Aspheric coefficient | | | | |
| | K | A14 | A16 | A18 | A20 | A22 |
| R1 | −2.1762E+01 | −1.3700E−02 | 2.6450E−03 | −2.9357E−04 | 1.4236E−05 | 0.0000E+00 |
| R2 | −6.5191E+00 | 1.9347E+00 | −1.7586E+00 | 7.7764E−01 | −1.3868E−01 | 0.0000E+00 |
| R3 | −3.5763E+00 | −1.0458E+01 | 9.1139E+00 | −4.3483E+00 | 8.6536E−01 | 0.0000E+00 |
| R4 | 3.0106E+01 | −3.3260E+04 | 3.0897E+05 | −2.0330E+06 | 9.2621E+06 | −2.8875E+07 |
| R5 | 1.7483E+01 | 2.1550E+05 | −2.2557E+06 | 1.6848E+07 | −8.9564E+07 | 3.3519E+08 |
| R6 | −1.8747E−01 | −1.0597E+05 | 5.3874E+05 | −1.9937E+06 | 5.3658E+06 | −1.0380E+07 |
| R7 | 7.0886E+04 | 2.4608E+04 | −9.4179E+04 | 2.6187E+05 | −5.3022E+05 | 7.7372E+05 |
| R8 | 6.3905E−01 | 2.3701E+03 | −4.8087E+03 | 7.1170E+03 | −7.6818E+03 | 5.9762E+03 |
| R9 | −1.5482E+03 | 1.4853E+03 | −2.7788E+03 | 3.8134E+03 | −3.8287E+03 | 2.7758E+03 |
| R10 | −9.6828E−01 | 2.3331E+01 | −2.9420E+01 | 2.7994E+01 | −1.9897E+01 | 1.0310E+01 |
| R11 | −4.2660E+00 | 1.6322E+00 | −1.0442E+00 | 4.7279E−01 | −1.5323E−01 | 3.5389E−02 |
| R12 | −3.8771E+00 | −8.3705E−02 | 2.6880E−02 | −6.2406E−03 | 1.0548E−03 | −1.2922E−04 |

| | Conic | | | | | |
|---|---|---|---|---|---|---|
| | coefficient | Aspheric coefficient | | | | |
| | K | A24 | A26 | A28 | A30 | / |
| R1 | −2.1762E+01 | 0.0000E+00 | 0.0000E+00 | 0.0000E+00 | 0.0000E+00 | / |
| R2 | −6.5191E+00 | 0.0000E+00 | 0.0000E+00 | 0.0000E+00 | 0.0000E+00 | / |
| R3 | −3.5763E+00 | 0.0000E+00 | 0.0000E+00 | 0.0000E+00 | 0.0000E+00 | / |
| R4 | 3.0106E+01 | 6.0261E+07 | −8.0255E+07 | 6.1460E+07 | −2.05150E+07 | / |
| R5 | 1.7483E+01 | −8.6111E+08 | 1.4434E+09 | −1.4204E+09 | 6.2196E+08 | / |
| R6 | −1.8747E−01 | 1.4050E+07 | −1.2621E+07 | 6.7560E+06 | −1.6303E+06 | / |
| R7 | 7.0886E+04 | −7.9249E+05 | 5.4055E+05 | −2.2046E+05 | 4.0662E+04 | / |
| R8 | 6.3905E−01 | −3.2613E+03 | 1.1840E+03 | −2.5673E+02 | 2.5147E+01 | / |
| R9 | −1.5482E+03 | −1.4132E+03 | 4.7905E+02 | −9.7051E+01 | 8.8883E+00 | / |
| R10 | −9.6828E−01 | −3.7552E+00 | 9.0680E−01 | −1.3002E−01 | 8.3684E−03 | / |
| R11 | −4.2660E+00 | −5.6918E−03 | 6.0616E−04 | −3.8425E−05 | 1.0975E−06 | / |
| R12 | −3.8771E+00 | 1.1258E−05 | −6.6808E−07 | 2.4496E−08 | −4.2378E−10 | / |

In addition, the subsequent Table 15 also lists the values corresponding to the parameters specified in the relationship formulas in the comparative embodiment.

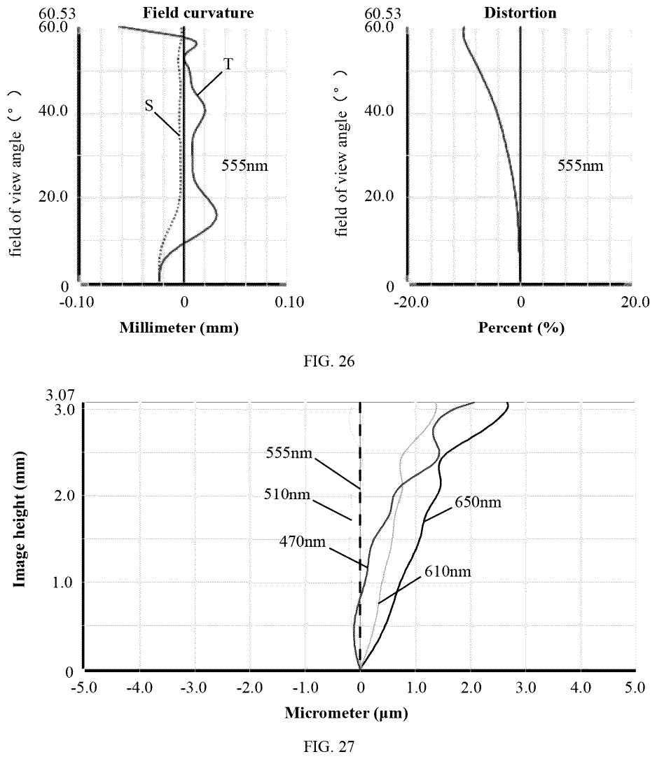

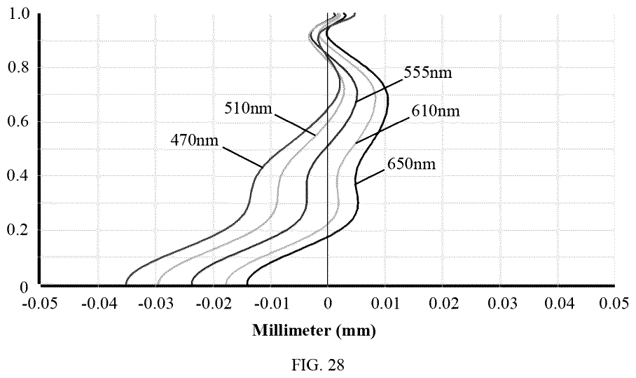

FIG. 26 shows a schematic diagram of field curvature and distortion of light with a wavelength of 555 nanometers after passing through the imaging optical lens 70 of the comparative embodiment. The field curvature S in FIG. 26 is a field curvature in the sagittal direction. FIG. 27 shows a schematic diagram of the lateral color of light with wavelengths of 470 nm, 510 nm, 555 nm, 610 nm, and 650 nm after passing through the imaging optical lens 70 of the comparative embodiment. FIG. 28 shows a schematic diagram of the longitudinal aberration of light with wavelengths of 470 nm, 510 nm, 555 nm, 610 nm, and 650 nm after passing through the imaging optical lens 70 of the comparative embodiment.

As shown in Table 15, the values of each parameter in the comparative embodiment corresponding to the parameters specified in the relationship formulas are also listed. Obviously, the imaging optical lens 70 of the comparative embodiment does not satisfy the above relationship formula-0.40≤(R1+R2)/(R1−R2)≤0.00.

In this embodiment, the pupil entering diameter (ENPD) of the microscope objective lens 70 is 0.852 mm, the full field-of-view (1.0H) image-height IH is 3.072 mm, and the field of view angle (FOV) of the 1.0 field of view is 121.06°. The imaging optical lens 70 has the characteristics of a large aperture, a wide angle, and ultra-thinness, and its on-axis and off-axis chromatic aberrations are fully corrected, with excellent optical performance.

TABLE 15

| Parameters & | First | Second | Third | Fourth |
|---|---|---|---|---|
| Relationship formula | Embodiment | Embodiment | Embodiment | Embodiment |
| (R1 + R2)/(R1 − R2) | −0.06 | 0.00 | 0.00 | −0.40 |
| (d1 + d2 + d3)/TTL | 0.26 | 0.20 | 0.30 | 0.20 |
| (f5 − f6)/f1 | −1.46 | −1.20 | −1.80 | −1.24 |
| (R9 + R10)/(R9 − R10) | 1.05 | 1.20 | 1.06 | 1.20 |
| f | 1.965 | 2.088 | 1.610 | 2.386 |
| f1 | −2.982 | −3.474 | −2.532 | −3.482 |
| f2 | 5.973 | 7.895 | 6.884 | 6.138 |
| f3 | 2.937 | 2.633 | 2.479 | 2.867 |
| f4 | −5.860 | −5.166 | −5.725 | −5.521 |
| f5 | 1.629 | 1.573 | 1.561 | 1.687 |
| f6 | −2.733 | −2.604 | −2.985 | −2.618 |
| FNO | 2.251 | 2.250 | 2.249 | 2.251 |
| TTL | 6.087 | 5.567 | 5.903 | 5.323 |
| IH | 3.201 | 3.184 | 3.100 | 3.269 |
| FOV | 119.85° | 115.67° | 129.20° | 109.77° |

| Parameters & | Fifth | Sixth | comparative | |
|---|---|---|---|---|
| Relationship formula | Embodiment | Embodiment | Embodiment | / |
| (R1 + R2)/(R1 − R2) | 0.00 | 0.00 | −0.47 | / |
| (d1 + d2 + d3)/TTL | 0.30 | 0.23 | 0.26 | / |
| (f5 − f6)/f1 | −1.42 | −1.49 | −1.42 | / |
| (R9 + R10)/(R9 − R10) | 1.00 | 1.05 | 1.04 | / |
| f | 1.791 | 2.066 | 1.917 | / |
| f1 | −2.944 | −2.959 | −3.041 | / |
| f2 | 7.136 | 4.547 | 6.614 | / |
| f3 | 2.838 | 3.778 | 2.868 | / |
| f4 | −5.741 | −5.484 | −5.524 | / |
| f5 | 1.498 | 1.582 | 1.606 | / |
| f6 | −2.677 | −2.816 | −2.711 | / |
| FNO | 2.250 | 2.251 | 2.250 | / |
| TTL | 5.968 | 6.058 | 5.958 | / |
| IH | 3.135 | 3.131 | 3.072 | / |
| FOV | 124.37° | 117.33° | 121.06° | / |

The imaging optical lens provided in the embodiments of the present disclosure is introduced in detail above. The principles and implementations of the present disclosure are explained herein by examples. The description of the above embodiments are only used to help understand the idea of the present disclosure. There may be changes in the implementations and the scope of application. In summary, the content of this specification should not be construed as limiting the present disclosure.

What is claimed is:

1. An imaging optical lens, comprising:
six lenses that are sequentially arranged from an object-side to an image-side as follows:
a first lens with negative refractive power;
a second lens with positive refractive power;
a third lens with positive refractive power;
a fourth lens with negative refractive power;
a fifth lens with positive refractive power; and
a sixth lens with negative refractive power,
wherein:
an object-side surface of the first lens is concave in a paraxial region, and an image-side surface of the first lens is concave in a paraxial region;
an object-side surface of the second lens is convex in a paraxial region, and an image-side surface of the second lens is concave in a paraxial region;
an object-side surface of the third lens is convex in a paraxial region, and an image-side surface of the third lens is convex in a paraxial region;
an object-side surface of the fourth lens is concave in a paraxial region, and an image-side surface of the fourth lens is concave in a paraxial region;
an object-side surface of the fifth lens is concave in a paraxial region, and an image-side surface of the fifth lens is convex in a paraxial region;
an object-side surface of the sixth lens is convex in a paraxial region, and an image-side surface of the sixth lens is concave in a paraxial region;
and wherein:
R1 represents a central curvature radius of the object-side surface of the first lens;
R2 represents a central curvature radius of the image-side surface of the first lens;
f1 represents a focal length of the first lens;
d1 represents an on-axis thickness of the first lens;
d2 represents an on-axis distance between the image-side surface of the first lens and the object-side surface of the second lens;
d3 represents an on-axis thickness of the second lens;
R9 represents a central curvature radius of the object-side surface of the fifth lens;
R10 represents a central curvature radius of the image-side surface of the fifth lens;
f5 represents a focal length of the fifth lens;
f6 represents a focal length of the sixth lens;
TTL represents a total optical length from an object surface to an image surface of the imaging optical lens;
and the imaging optical lens satisfies the following relationships:
$$- 0.4 \leq ( R 1 + R 2 ) / ( R 1 - R 2 ) \leq 0. ;$$
$$0.2 \leq ( d 1 + d 2 + d 3 ) / TTL \leq 0 \text{.30} ;$$
$$- 1.8 \leq ( f 5 - f 6 ) / f 1 \leq - 1 \text{.20} ;$$
$$1. \leq ( R 9 + R 10 ) / ( R 9 - R 10 ) \leq 1.2 .$$

2. The imaging optical lens of claim 1, wherein f2 represents a focal length of the second lens, f3 represents a focal length of the third lens, and the imaging optical lens satisfies a following relationship:
$$1.2 \leq f 2 / f 3 \leq 3. .$$

3. The imaging optical lens of claim 1, wherein IH represents a full field-of-view (1.0H) image-height of the imaging optical lens, f represents a focal length of the imaging optical lens, and the imaging optical lens satisfies a following relationship:
$$0.8 \leq IH * f / TTL \leq 1.5 .$$

4. The imaging optical lens of claim 1, wherein f represents a focal length of the imaging optical lens, and the imaging optical lens further satisfies a following relationship:
$$- 1.67 \leq f 1 / f \leq - 1.43 ;$$
$$0.05 \leq d 1 / TTL \leq 0.09 .$$

5. The imaging optical lens of claim 1, wherein f represents a focal length of the imaging optical lens, f2 represents a focal length of the second lens, and the imaging optical lens satisfies the following relationships:
$$- 4.02 \leq ( R 3 + R 4 ) / ( R 3 - R 4 ) \leq - 2.03 ;$$
$$2.2 \leq f 2 / f \leq 4.28 ;$$
$$0.1 \leq d 3 / TTL \leq 0.14 .$$

6. The imaging optical lens of claim 1, wherein f represents a focal length of the imaging optical lens, R5 represents a central curvature radius of an object-side surface of the third lens, R6 represents a central curvature radius of an image-side surface of the third lens, f3 represents a focal length of the third lens, d5 represents an on-axis thickness of the third lens, and the imaging optical lens satisfies the following relationships:
$$0.07 \leq ( R 5 + R 6 ) / ( R 5 - R 6 ) \leq 0.3 ;$$
$$1.2 \leq f 3 / f \leq 1.83 ;$$
$$0.08 \leq d 5 / TTL \leq 0.11 .$$

7. The imaging optical lens of claim 1, wherein f represents a focal length of the imaging optical lens, R7 represents a central curvature radius of an object-side surface of the fourth lens, R8 represents a central curvature radius of an image-side surface of the fourth lens, f4 represents a focal length of the fourth lens, d7 represents an on-axis thickness of the fourth lens, and the imaging optical lens satisfies the following relationships:
$$0.74 \leq ( R 7 + R 8 ) / ( R 7 - R 8 ) \leq 0.98 ;$$
$$- 3.56 \leq f 4 / f \leq - 2 \text{.31} ;$$
$$0.04 \leq d 7 / TTL \leq 0.06 .$$

8. The imaging optical lens of claim 1, wherein f represents a focal length of the imaging optical lens, d9 represents an on-axis thickness of the fifth lens, and the imaging optical lens satisfies the following relationships:
$$0.7 \leq f 5 / f \leq 0.97 ;$$
$$0.19 \leq d 9 / TTL \leq 0.23 .$$

9. The imaging optical lens of claim 1, wherein f represents a focal length of the imaging optical lens, R11 represents a central curvature radius of an object-side surface of the sixth lens, R12 represents a central curvature radius of an image-side surface of the sixth lens, d11 represents an on-axis thickness of the sixth lens, and the imaging optical lens satisfies the following relationships:
$$2.76 \leq ( R 11 + R 12 ) / ( R 11 - R 12 ) \leq 3.12 ;$$
$$- 1.86 \leq f 6 / f \leq - 1 \text{.09} ;$$
$$0.07 \leq d 11 / TTL \leq 0.09 .$$

10. The imaging optical lens of claim 1, wherein IH represents a full field-of-view (1.0H) image-height of the imaging optical lens, and the imaging optical lens satisfies the following relationship:
$$1.6 \leq TTL / IH \leq 1.94 .$$
